(19) United States
(12) Patent Application Publication
(10) Pub. No.: US 2025/0159114 A1
(43) Pub. Date: May 15, 2025

(54) PROJECTION APPARATUS AND METHOD FOR DRIVING LIGHT SOURCE THEREOF

(71) Applicant: Hisense Laser Display Co., Ltd, Qingdao City (CN)

(72) Inventor: Rongrong CUI, Qingdao City (CN)

(73) Assignee: Hisense Laser Display Co., Ltd, Qingdao City (CN)

(21) Appl. No.: 19/022,734

(22) Filed: Jan. 15, 2025

Related U.S. Application Data
(63) Continuation of application No. PCT/CN2023/102502, filed on Jun. 26, 2023.

(30) Foreign Application Priority Data
Jul. 25, 2022 (CN) 202210876776.4

(51) Int. Cl. H04N 9/31; G09G 3/00

(52) U.S. Cl. CPC H04N 9/3105; G09G 3/002; H04N 9/3182; H04N 9/3197; G09G 2310/0297

(57) ABSTRACT

A projection apparatus includes a light source driving circuit, a display control circuit, a main control circuit, and a light source assembly. The display control circuit is configured to transmit a first initial enable signal and a second initial enable signal to the light source driving circuit. The main control circuit is configured to transmit a digital control signal to the light source driving circuit. The light source assembly includes a plurality of groups of light sources. The light source driving circuit is configured to provide driving current to the plurality of groups of light sources in response to the first initial enable signal, the second initial enable signal and the digital control signal. Any group of the plurality of groups of light sources is configured to emit light under driving of the driving current. A size of the light valve is less than a size threshold.

### CROSS-REFERENCE TO RELATED APPLICATIONS

This application is a by-pass continuation application under 35 U.S.C. § 1.11 (a) of International Application No. PCT/CN2023/102502, filed on Jun. 26, 2023, which claims priority to Chinese Patent Application No. 202210876776.4, filed on Jul. 25, 2022, the entire contents of which are incorporated herein by reference in their entireties.

### TECHNICAL FIELD

The present disclosure relates to the field of projection display technologies, and in particular, to a projection apparatus and a method for driving a light source thereof.

### BACKGROUND

With the development of optoelectronic technology, projection apparatuses have been used widely. While users have higher and higher requirements on display effect of projection images projected by the projection apparatus, a demand for miniaturization of the projection apparatus is also increasing.

The miniaturized projection apparatus uses an LED light source to obtain a light beam, modulates the light beam emitted by the light source into an image beam through a light valve, and projects the image beam onto a projection screen through a projection lens.

### SUMMARY

In an aspect, a projection apparatus is provided. The projection apparatus includes a light source driving circuit, a display control circuit, a main control circuit, a light source assembly and a light valve. The display control circuit is connected to the light source driving circuit, and is configured to transmit a first initial enable signal and a second initial enable signal to the light source driving circuit. The main control circuit is connected to the light source driving circuit, and is configured to transmit a digital control signal to the light source driving circuit. The light source assembly includes a plurality of groups of light sources. The light source driving circuit is connected to the plurality of groups of light sources, and the light source driving circuit is configured to provide a driving current to the plurality of groups of light sources in response to the first initial enable signal, the second initial enable signal and the digital control signal. Any group of the plurality of groups of light sources is configured to emit light under driving of the driving current. A size of the light valve is less than a size threshold. The light valve is configured to modulate the light emitted by the light sources into image beams.

In another aspect, a method for driving a light source of a projection apparatus is provided. The projection apparatus includes: a display control circuit, a main control circuit, a light source driving circuit, a light source assembly and a light valve. The light source assembly includes a plurality of groups of light sources. A size of the light valve is less than a size threshold. The method includes that the display control circuit transmits a first initial enable signal and a second initial enable signal to the light source driving circuit; the main control circuit transmits a first image signal to the display driving circuit; the light source driving circuit provides a driving current to the plurality of groups of light sources in the light source assembly in response to the first initial enable signal, the second initial enable signal and the digital control signal; the any group of the plurality of groups of light sources emit light under driving of the driving current; and the light valve modulates the light emitted by the plurality of groups of light sources into image beams.

### BRIEF DESCRIPTION OF THE DRAWINGS

FIG. 1 is a perspective view of a projection apparatus, in accordance with some embodiments of the present disclosure;

FIG. 2 is a structural diagram of a projection apparatus with a housing removed, in accordance with some embodiments of the present disclosure;

FIG. 3 is a block diagram of a projection apparatus, in accordance with some embodiments of the present disclosure;

FIG. 4 is a block diagram of another projection apparatus, in accordance with some embodiments of the present disclosure;

FIG. 5A is a block diagram of yet another projection apparatus, in accordance with some embodiments of the present disclosure;

FIG. 5B is a block diagram of yet another projection apparatus, in accordance with some embodiments of the present disclosure;

FIG. 5C is a block diagram of yet another projection apparatus, in accordance with some embodiments of the present disclosure;

FIG. 6 is a block diagram of yet another projection apparatus, in accordance with some embodiments of the present disclosure;

FIG. 7 is a circuit diagram of an encoding circuit, in accordance with the embodiments of the present disclosure;

FIG. 8 is a circuit diagram of another encoding circuit, in accordance with the embodiments of the present disclosure;

FIG. 9 is a circuit diagram of a digital-to-analog conversion circuit, in accordance with the embodiments of the present disclosure;

FIG. 10 is a circuit diagram of another digital-to-analog conversion circuit, in accordance with the embodiments of the present disclosure;

FIG. 11 is a structural diagram of an optical engine, in accordance with the embodiments of the present disclosure;

FIG. 12 is a structural diagram of another optical engine, in accordance with the embodiments of the present disclosure;

FIG. 13A is a flowchart of a method for driving a light source, in accordance with some embodiments of the present disclosure;

FIG. 13B is a flowchart of another method for driving a light source, in accordance with some embodiments of the present disclosure;

FIG. 14A is a flowchart of yet another method for driving a light source, in accordance with some embodiments of the present disclosure;

FIG. 14B is a flowchart of yet another method for driving a light source, in accordance with some embodiments of the present disclosure;

FIG. 15A is a flowchart of yet another method for driving a light source, in accordance with some embodiments of the present disclosure;

FIG. 15B is a flowchart of yet another method for driving a light source, in accordance with some embodiments of the present disclosure;

FIG. 16 is a flowchart of yet another method for driving a light source, in accordance with some embodiments of the present disclosure;

FIG. 17 is a flowchart of yet another method for driving a light source, in accordance with some embodiments of the present disclosure;

FIG. 18 is a flowchart of yet another method for driving a light source, in accordance with some embodiments of the present disclosure; and

FIG. 19 is a flowchart of yet another method for driving a light source, in accordance with some embodiments of the present disclosure.

### DESCRIPTION OF THE EMBODIMENTS

Some embodiments of the present disclosure will be described clearly and completely with reference to the accompanying drawings; however, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” “In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the expression “connected” and derivatives thereof may be used. The term “connected” should be understood in a broad sense; for example, “connected” may represent a fixed connection, a detachable connection, or connected as an integral body; “connected” may be directly “connected” or indirectly “connected” through an intermediate means.

The phrase “at least one of A, B, and C” has the same meaning as the phrase “at least one of A, B, or C”, both including the following combinations of A, B, and C: only A, only B, only C, a combination of A and B, a combination of A and C, a combination of B and C, and a combination of A, B, and C.

The phrase “A and/or B” includes following three combinations: only A, only B, and a combination of A and B.

The phrase “applicable to” or “configured to” as used herein indicates an open and inclusive expression, which does not exclude apparatuses that are applicable to or configured to perform additional tasks or steps.

The term “about”, “substantially” and “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

As used herein, “parallel”, “perpendicular” and “equal” include the stated conditions and the conditions similar to the stated conditions, and the range of the similar conditions is within the acceptable deviation range, where the acceptable deviation range is determined by a person of ordinary skill in the art in consideration of the measurement in question and the error associated with the measurement of a specific quantity (i.e., the limitation of the measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°. The term “equal” includes absolute equality and approximate equality, and an acceptable range of deviation of the approximate equality may be, for example, a difference between two equals of less than or equal to 5% of either of the two equals.

With the development of optoelectronic technology, projection apparatuses have been used widely. While users have higher and higher requirements on display effect of projection images projected by the projection apparatus, a demand for miniaturization of the projection apparatus is also increasing.

In general, a projection apparatus includes a light source, a light valve (e.g., a digital micromirror device, DMD) and a projection lens. The light source is configured to provide a light beam, the DMD is configured to modulate the light beam emitted by the light source into an image beam (i.e., a projection image), and the projection lens is configured to project the image beam onto a projection screen. For example, an LED light source may be used as the light source, or a laser source may be used as the light source.

Some small-sized light valves in the related art use LED light sources, and thus it is generally difficult to increase the brightness. The use of laser sources may satisfy the high brightness requirements, but it is necessary to redesign a driving scheme for the laser source, which may increase the manufacturing cost of the projection equipment. For example, the LED light source is suitable for a high-current and low-voltage driving solution, while the laser source is suitable for a low-current and relatively slightly higher-voltage driving solution.

In order to solve the above technical problems, some embodiments of the present disclosure provide a projection apparatus. The projection apparatus may provide driving current to a plurality of groups of light sources in a light source assembly in response to a first initial enable signal, a second initial enable signal, and a digital control signal through a light source driving circuit, so that the plurality of groups of light sources emit light. In this case, the plurality of groups of light sources may be LED light sources or laser sources, so that the brightness of the light sources may be increased while reducing the size of the projection apparatus (e.g., by selecting a small-sized light valve).

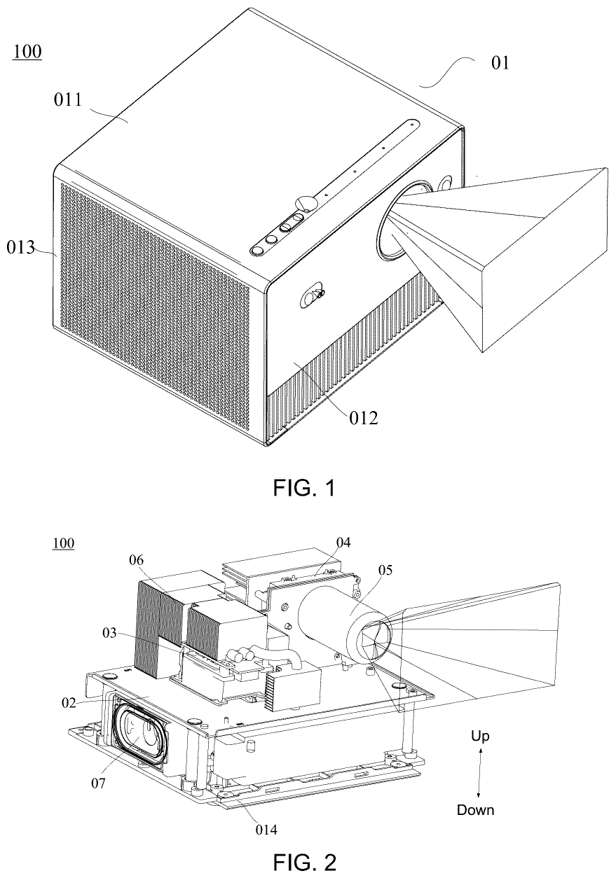

FIG. 1 is a perspective view of a projection apparatus, in accordance with some embodiments of the present disclosure.

Referring to FIG. 1, the projection apparatus 100 includes a housing 01 and structures such as an optical engine, a circuit board, a heat dissipation assembly, and an audio device located inside the housing 01. The housing 01 includes an upper housing 011, a front housing 012, a side wall 013, a bottom housing 014 (see FIG. 2) and a rear housing. For example, the projection apparatus 100 is a micro projection apparatus.

FIG. 2 is a structural diagram of a projection apparatus with a housing removed, in accordance with some embodiments of the present disclosure. For example, FIG. 2 is a schematic diagram of a portion of the internal structure of the projection apparatus in FIG. 1 after the housing is removed.

Referring to FIG. 2, the projection apparatus 100 further includes a carrying plate 02, a laser source 03, an optical machine 04, a projection lens 05, a heat dissipation device 06 and an audio device 07.

The carrying plate 02 is disposed in the housing 01, and the carrying plate 02 and the bottom housing 014 divide an inner space of the housing 01 into two accommodating cavities (e.g., an upper accommodating cavity and a lower accommodating cavity) arranged along an up-down direction (e.g., a height direction of the projection apparatus).

In some embodiments, the carrying plate 02 may be a metal plate and serve as a supporting member for the plurality of functional components of the projection apparatus 100, so as to facilitate installation of the functional components.

In some embodiments, the entirety of the carrying plate 02 may be approximately in a shape of a flat plate, so that the two separated accommodating cavities may be in a regular shape, which is convenient for the layout and design of related functional components, and also convenient for the installation of related functional components.

The laser source 03 is disposed in the upper accommodating cavity and connected to the carrying plate 02. The laser source 03 is configured to provide a laser beam for the projection apparatus 100. In some embodiments, the laser source 03 may be directly connected to the carrying plate 02 through a connector. In some embodiments, the laser source 03 may also be indirectly connected to the carrying plate 02 through the optical machine 04 or the projection lens 05.

In some embodiments, the laser source 03 may be a tri-color laser source. The tri-color laser source includes a red laser device assembly, a blue laser device assembly, a green laser device assembly, and a plurality of optical lenses. The plurality of optical lenses may homogenize and converge the laser beam.

In some embodiments, the laser source 03 may further not be the tri-color laser source, for example, the laser source 03 may be a monochromatic laser source or a dual-color laser source. The monochromatic laser source may use the blue laser device assembly to excite phosphors to produce two other primary colors of light (e.g., red fluorescence and green fluorescence), or to produce more than two colors of fluorescence. The dual-color laser source may use the blue laser device assembly and the red laser device assembly, and the blue laser device assembly excites the phosphor to generate green fluorescence (or other color of fluorescence).

In order to modulate the laser beam from the laser source 03, the optical machine 04 is structurally connected to the laser source 03, and is connected to the carrying plate 02. For example, the optical machine 04 may be directly connected to the carrying plate 02 through a connector.

In some embodiments, the optical machine 04 may include a first lens group. For example, the first lens group includes a total internal reflection (TIR) prism and a reverse total internal reflection (RTIR) lens. The first lens group is configured to form an illumination path, so that the illumination light beam may be incident on a core component in the optical machine 04, that is, the light valve. The light valve is configured to modulate the laser beam, and make the modulated laser beam incident on a second lens group of the projection lens 05 for imaging.

Based on this, for example, the light valve may be a digital micromirror device (DMD) or a liquid crystal on silicon (LCOS), which is not limited here.

In order to project the light beam onto a projection screen or other projection medium (e.g., a wall), the projection lens 05, the laser source 03 and the optical machine 04 are disposed in a same accommodating cavity (e.g., the upper accommodating cavity) and connected to the carrying plate 02. The laser source 03, the optical machine 04 and the projection lens 05 are arranged and connected in sequence along a transmission direction of the laser beam.

In some embodiments, the projection lens 05 may be an ultra-short-throw projection lens, which includes a refractive lens group and a reflective lens group. The ultra-short-throw projection lens is configured to receive the laser beam modulated by the optical machine 04 to perform imaging. An ultra-short-throw projection apparatus may implement a small projection ratio (the projection ratio is a ratio of a vertical distance from a center point of a light-exit surface of the projection lens 05 to a plane where the projection screen or other projection medium is located to a width of a display region on a projection plane, and, for example, the width of the display region refers to a size of the display region along a horizontal direction), such as less than or equal to 0.2.

Therefore, when projecting an image, a distance between the projection apparatus 100 and the projection plane may be shortened to reduce an occupied space of the projection display system.

In some embodiments, the projection lens 05 may further be a telephoto lens. The design difficulty of the telephoto lens is low, the cost is low, and the size is small. Therefore, the telephoto lens is suitable for the projection apparatus (e.g., a micro projection apparatus).

The heat dissipation device 06 is mainly configured to at least dissipate heat for the laser source 03.

In some embodiments, the heat dissipation device 06 may include a liquid cooling system. The liquid cooling system includes at least one cooling head, a cooling row and connecting pipelines. The cooling head may be in contact with at least one of the laser source 03, the optical machine 04, the projection lens 05 and other heat-generating components (e.g., the circuit board). The heat dissipation device 06 may further include a heat dissipation system, which includes a heat exchange plate, a heat pipe, a heat dissipation fin, etc. The heat exchange plate may be in contact with at least one of the laser source 03, the optical machine 04, the projection lens 05 and other heat-generating components (e.g., the circuit board). The heat dissipation device 06 may further include an air cooling dissipation system, which includes components such as a fan.

It can be understood that the above-mentioned different heat dissipation methods may be used alone or in combination, and the present disclosure is not limited thereto.

In order to ensure the performance of the audio device 07 and make the overall structure of the projection apparatus 100 compact, the audio device 07 is disposed in the lower accommodating cavity below the carrying plate. For example, the audio device 07 may be connected to the bottom housing 014. For example, the audio device 07 may also be connected to other walls of the housing 01. For example, the audio device 07 may also be connected to the carrying plate 02.

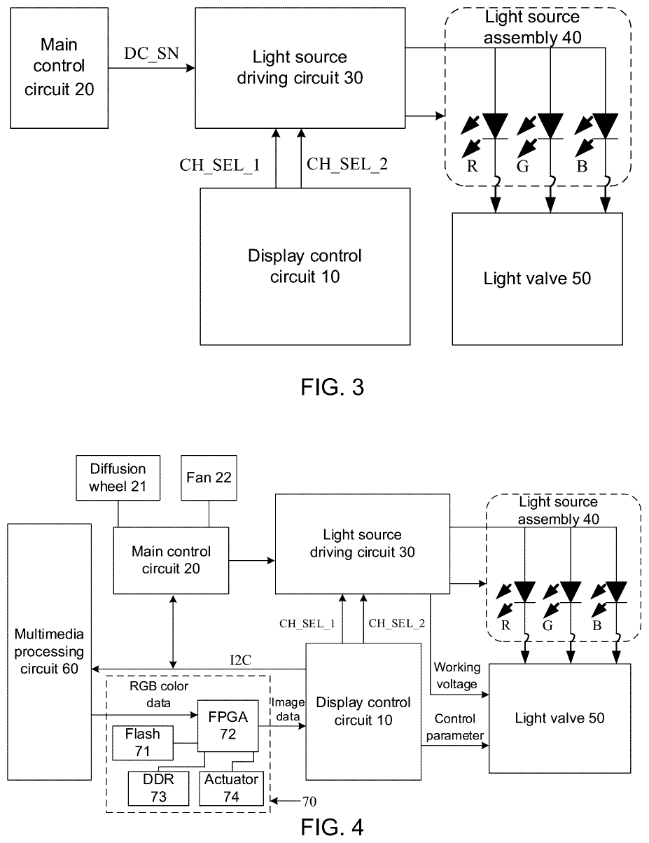

The circuit architecture of the projection apparatus 100 will be described below with reference to FIG. 3.

FIG. 3 is a block diagram of a projection apparatus, in accordance with some embodiments of the present disclosure. Referring to FIG. 3, the projection apparatus 100 includes a display control circuit 10, a main control circuit 20, a light source driving circuit 30, a light source assembly 40 and a light valve 50. For example, the laser source assembly 40 includes a plurality of groups of light sources.

Referring to FIG. 3, the display control circuit 10 is connected to the light source driving circuit 30, and the display control circuit 10 is configured to transmit a first initial enable signal CH_SEL_1 and a second initial enable signal CH_SEL_2 to the light source driving circuit 30.

In some embodiments, the display control circuit 10 may generate the first initial enable signal CH_SEL_1 and the second initial enable signal CH_SEL_2 for controlling a working state of the light source driving circuit 30 based on image data of a projection image to be displayed. The first initial enable signal CH_SEL_1 is also referred to as a first light source lighting enable signal, and the second initial enable signal CH_SEL_2 is also referred to as a second light source lighting enable signal.

The main control circuit 20 is connected to the light source driving circuit 30, and the main control circuit 20 is configured to transmit a digital control signal DC_SN to the light source driving circuit 30.

In some embodiments, the digital control signal DC_SN is a level signal outputted from an output terminal of the main control circuit 20. Alternatively, the digital control signal DC_SN is a digital pulse width modulation (PWM) signal output by the main control circuit 20 through a digital pulse width modulation interface. Alternatively, the digital control signal DC_SN is a serial peripheral interface (SPI) signal output by the main control circuit 20 through a serial peripheral interface.

Continuing to refer to FIG. 3, the light source driving circuit 30 is connected to the plurality of groups of light sources in the light source assembly 40, and is configured to provide driving current to the plurality of groups of light sources in the light source assembly 40 in response to the first initial enable signal CH_SEL_1, the second initial enable signal CH_SEL_2 and the digital control signal DC_SN. Any group of light sources in the plurality of groups of light sources are configured to emit light under driving of the driving current.

In some embodiments, the any group of light sources in the light source assembly 40 are laser sources, and accordingly, the projection apparatus is a laser projection apparatus. Alternatively, the any group of light sources in the light source assembly 40 are light-emitting diodes (LEDs) or other types of light sources.

In some embodiments, the colors of the plurality of groups of light sources in the light source assembly 40 are the same or different. For example, referring to FIG. 3, the plurality of groups of light sources include a group of red (R) light sources, a group of green (G) light sources, and a group of blue (B) light sources.

The first initial enable signal CH_SEL_1 and the second initial enable signal CH_SEL_2 are configured to control the light source driving circuit 30 to transmit the driving current to the light source assembly 40, or not to transmit the driving current.

For the function of the digital control signal DC_SN, in some embodiments, in a case where the any group of light sources in the light source assembly 40 are laser sources, the digital control signal DC_SN is configured to control a magnitude of the driving current transmitted from the light source driving circuit 30 to the light source assembly 40.

In some embodiments, in a case where the plurality of groups of light sources in the light source assembly 40 are a plurality of groups of LED light sources, the digital control signal DC_SN may control the working state of the light source driving circuit 30. For example, in a case where the digital control signal DC_SN is at an active level, the light source driving circuit 30 is in the working state, and in a case where the digital control signal DC_SN is at an inactive level, the light source driving circuit 30 is in a state of stopping working.

The light valve 50 is configured to modulate the light emitted by the light sources into image beams. A size of the light valve 50 is less than a size threshold.

In some embodiments, the light valve 50 is configured to modulate the light emitted by the plurality of groups of light sources in the light source assembly 40 into the image beams based on the image data of the projection image to be displayed. The image beam is projected onto the projection screen through the projection lens to form the projection image.

For example, the light valve 50 is a DMD. The size of the light valve 50 is a size of the DMD. The size of the DMD is a size of a display chip used to carry the micromirrors in the DMD. DMDs of different sizes carry different numbers of micromirrors, and the brightness of the modulated image beams is also different.

Since a ratio of a length to a width of the DMD is generally fixed (e.g., an aspect ratio is 4:3), the size of the DMD may be defined based on a length of a diagonal of the DMD. For example, a DMD with a diagonal length of 0.33 inches is also referred to as a 0.33-type DMD.

In some embodiments, the length of the diagonal of the DMD corresponding to the size threshold is 0.47 inches. For example, 2.07 million micromirrors are arranged on the display chip in the 0.47-type DMD.

In some embodiments, in a case where the size of the light valve 50 is less than the size threshold, the number of micromirrors carried by the display chip in the light valve 50 is also less than a certain threshold. Accordingly, the volume of optical components, peripheral circuit boards and structural mounting members are all reduced, thereby facilitating the miniaturization of the projection apparatus. Therefore, a projection apparatus in which the size of the light valve 50 is less than the size threshold (that is, the diagonal length of the DMD is less than 0.47 inches) is also referred to as a micro projection apparatus. For example, the size of the light valve is 0.33 inches, or 0.23 inches.

It can be understood that the driving circuit of the micro projection apparatus may not select an expensive or complex driving circuit in general. Therefore, the light source driving circuit in some embodiments of the present disclosure may implement the signal conversion in the micro projection apparatus and satisfy low-cost product application requirements.

In summary, some embodiments of the present disclosure provide a projection apparatus, in which a light source driving circuit may provide the driving current to the plurality of light sources in the light source assembly in response to the first initial enable signal and the second initial enable signal transmitted by the display control circuit, and the digital control signal transmitted by the main control circuit. The plurality of groups of light sources in the light source assembly may emit light under driving of the driving current. The light valve in the projection apparatus may modulate the light emitted by the light sources into the image beams.

FIG. 4 is a block diagram of another projection apparatus, in accordance with some embodiments of the present disclosure. Referring to FIG. 4, the projection apparatus 100 further includes a multimedia processing circuit 60 and an image processing circuit 70.

As shown in FIG. 4, the multimedia processing circuit 60 is connected to the image processing circuit 70. The multimedia processing circuit 60 is configured to receive video signals through various communication interfaces and process the video signals to convert the video signals into red green blue (RGB) color data in a low-voltage differential signaling (LVDS) format.

Furthermore, the multimedia processing circuit 60 is further connected to the display control circuit 10 and the main control circuit 20 through an inter-integrated circuit (I2C) bus, thereby implementing data communication with the display control circuit 10 and the main control circuit 20.

The image processing circuit 70 is configured to process the RGB color data in the LVDS format output by the multimedia processing circuit 60, and transmit the processed image data to the display control circuit 10.

In some embodiments, referring to FIG. 4, the image processing circuit 70 includes a Flash 71, a field-programmable gate array (FPGA) 72, a double data rate (DDR) synchronous dynamic random access memory 73, and an actuator 74.

The Flash 71 is configured to store the running program in the FPGA 72. In a case where the various devices in the image processing circuit 70 are powered on, the program in the Flash 71 starts to run, and the FPGA 72 may convert the RGB color data in the LVDS format output by the multimedia processing circuit 60 to obtain image data of a plurality of frames of sub-images of the projection image to be projected and displayed.

For example, buffered image data of the plurality of frames of sub-images are stored in the DDR 73. Furthermore, the FPGA 72 may send a vibrating lens driving current and a control parameter of the vibrating lens to a vibrating lens driving circuit (e.g., the actuator 74 shown in FIG. 4) in the projection apparatus based on the image data of the plurality of frames of sub-images, and the vibrating lens circuit may then drive the vibrating lens to vibrate. In addition, the FPGA 72 may further transmit the generated image data of the plurality of frames of sub-images to the display control circuit 10.

The display control circuit 10 is further configured to encode the plurality of frames of sub-image data into binary bit image data that can be displayed by the light valve 50, and send a corresponding control parameter to the light valve 50 to control the light valve 50 to display the image data. For example, the display control circuit 10 may be a digital light processing (DLP) chip. For example, the display control circuit 10 is a DLPC343X chip.

In some embodiments, as shown in FIG. 4, the projection apparatus 100 further includes a diffusion wheel 21 and a fan 22. The diffusion wheel 21 and the fan 22 are respectively connected to the main control circuit 20. The main control circuit 20 is further configured to control the working states of components such as the diffusion wheel 21 and the fan 22.

In some embodiments, the main control circuit 20 is a microcontroller unit (MCU), also known as a single chip microcomputer.

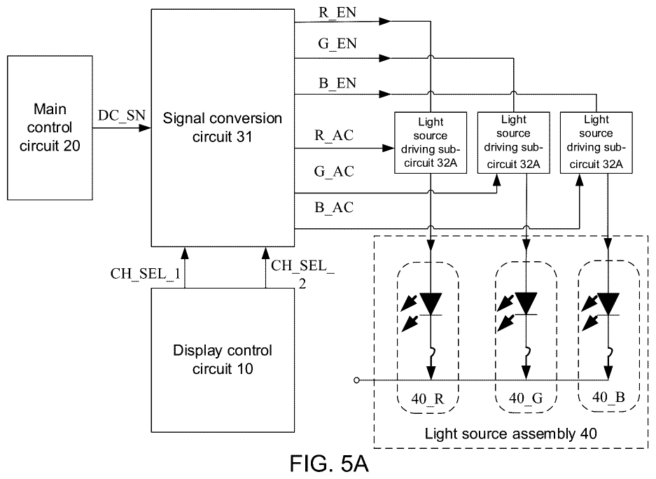

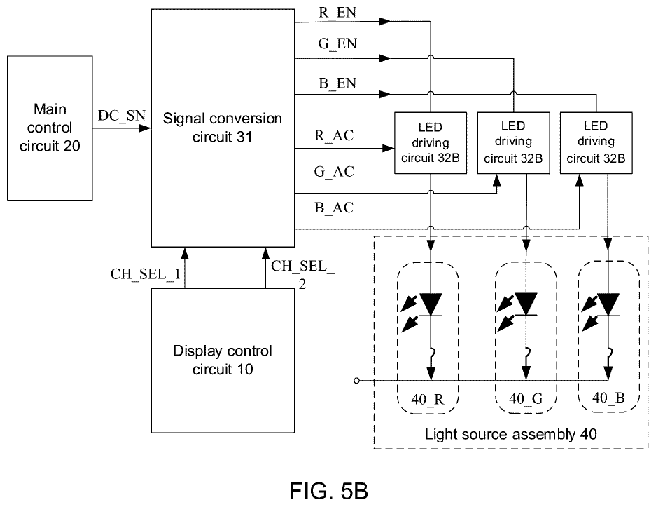

In some embodiments, as shown in FIG. 5A, the light source driving circuit 30 includes a signal conversion circuit 31 and a plurality of light source driving sub-circuits 32A connected to the plurality of groups of light sources.

The display control circuit 10 and the main control circuit 20 are connected to the signal conversion circuit 31. The display control circuit 10 is configured to transmit the first initial enable signal CH_SEL_1 and the second initial enable signal CH_SEL_2 to the signal conversion circuit 31. The main control circuit 20 is configured to transmit the digital control signal DC_SN to the signal conversion circuit 31. The digital control signal DC_SN is a digital PWM signal or an SPI signal.

It can be understood that the first initial enable signal CH_SEL_1 and the second initial enable signal CH_SEL_2 cannot directly control the working state of the light source driving sub-circuit 32A, therefore, the display control circuit 10 may first transmit the first initial enable signal CH_SEL_1 and the second initial enable signal CH_SEL_2 to the signal conversion circuit 31 for further processing.

The active level of the first initial enable signal CH_SEL_1 and the second initial enable signal CH_SEL_2 is a high level, and the level amplitude of the high level is 1.8V.

Referring to FIG. 5A, the signal conversion circuit 31 is further connected to the plurality of light source driving sub-circuits 32A. The signal conversion circuit 31 is configured to convert the first initial enable signal CH_SEL_1 and the second initial enable signal CH_SEL_2 into a plurality of target enable signals corresponding to the plurality of groups of light sources, transmit any one of the plurality of target enable signals to a corresponding light source driving sub-circuit 32A, output a plurality of analog current control signals based on the digital control signal DC_SN, and transmit any one of the plurality of analog current control signals to the corresponding light source driving sub-circuit 32A.

The any one of the plurality of light source driving sub-circuits 32A is configured to provide the driving current to a group of light sources connected to the any one of the plurality of light source driving sub-circuits 32A in response to the received target enable signal and analog current control signal. The light source is configured to emit light under the driving of the driving current provided by a light source driving sub-circuit 32A connected to the light source.

Hereinafter, the structure and working principle of the light source driving circuit 30 will be introduced by taking an example in which the plurality of groups of light sources in the light source assembly 40 of the projection apparatus are a plurality of groups of LED light sources.

In a case where the plurality of groups of light sources in the light source assembly 40 are the plurality of groups of LED light sources, the light source driving circuit 30 is configured to provide the driving current to the plurality of groups of LED light sources based on the first initial enable signal CH_SEL_1 and the second initial enable signal CH_SEL_2 in a case where the digital control signal DC_SN is at an active level. The light source assembly 40 includes a plurality of groups of light sources of different colors, and the color of the light beam emitted by the light source assembly 40 is matched and synchronized with the color data displayed by the light valve 50.

For example, the light source driving circuit 30 includes a power management chip and peripheral circuits of the power management chip.

In some embodiments, the light source driving circuit 30 is further configured to provide the light valve 50 with a plurality of voltages for controlling the operation of the light valve. For example, the light source driving circuit 30 provides a working voltage, a bias voltage, a reset voltage, etc. to the light valve 50.

The brightness of the light beam projected by the LED light source in the light source assembly 40 is low, which results in a low brightness of the projection image projected by the projection apparatus 100. Therefore, a projection apparatus using the LED light source is generally used in scenes with a small projection size of the projection image.

In a case where the projection size of the projection image is great, the brightness of the laser beam emitted by the laser source is high. Therefore, it may ensure that the brightness of the image projected on a large projection screen is high by replacing the LED light sources in the above-mentioned projection apparatus 100 with laser sources. However, since the LED light source is driven by a large current (e.g., 16 A) and a low voltage (e.g., less than 5V), and the laser source is driven by a large voltage (e.g., 30V) and a low current (e.g., 3 A), the light source driving circuit 30 in the above-mentioned LED type projection apparatus is not capable of directly driving the laser source.

In some embodiments, as shown in FIG. 5B, the plurality of groups of light sources include N groups of LED light sources. The plurality of light source driving sub-circuits 32A include N LED driving circuits 32B, and the N LED driving circuits 32B are correspondingly connected to N groups of LED light sources. The signal conversion circuit 31 is connected to the N LED driving circuits 32B.

The signal conversion circuit 31 is configured to convert the first initial enable signal CH_SEL_1 and the second initial enable signal CH_SEL_2 into N target enable signals corresponding to the N groups of LED light sources, transmit any one of the N target enable signals to the corresponding LED driving circuit 32B, output N analog current control signals based on the digital control signal DC_SN, and transmit any one of the N analog current control signals to the corresponding LED driving circuit 32B.

The any one of the N LED driving circuits 32B is configured to provide a driving current to a group of LED light sources connected to the any one of the LED driving circuits 32B in response to the received target enable signal and analog current control signal.

The LED light source is configured to emit light under the driving of the driving current provided by an LED driving circuit 32B connected to the LED light source.

The projection apparatus of some embodiments of the present disclosure may implement the driving of the laser source. With reference to FIG. 5C, the structure and working principle of the projection apparatus 100 will be introduced below by taking an example in which the plurality of groups of light sources of the light source assembly 40 in the projection apparatus 100 are the plurality of groups of laser sources. It will be noted that the following embodiments only take the plurality of groups of light sources as laser sources as an example, and the present disclosure does not limit the type of light sources. In some embodiments, in a case where the laser source is replaced with the LED light source, the same or substantially the same beneficial effects may be achieved, which will not be repeated in the present disclosure.

FIG. 5C is a block diagram of yet another projection apparatus, in accordance with some embodiments of the present disclosure. Referring to FIG. 5C, the plurality of groups of light sources are N groups of laser devices, and N is an integer greater than 2. For example, a value of N is 3.

The light source driving circuit 30 includes a signal conversion circuit 31 and N laser device driving circuits 32 connected to the N groups of laser devices, correspondingly. For example, the plurality of light source driving sub-circuits 32A include N laser device driving circuits 32.

In some embodiments, the signal conversion circuit 31 may be disposed in the above-mentioned light source driving circuit 30.

The display control circuit 10 and the main control circuit 20 are respectively connected to the signal conversion circuit 31. The display control circuit 10 is configured to transmit the first initial enable signal CH_SEL_1 and the second initial enable signal CH_SEL_2 to the signal conversion circuit 31. The main control circuit 20 is configured to transmit the digital control signal DC_SN to the signal conversion circuit 31. The digital control signal DC_SN is a digital PWM signal or an SPI signal.

It can be understood that the first initial enable signal CH_SEL_1 and the second initial enable signal CH_SEL_2 is not capable of directly controlling the working state of the laser device driving circuit 32. Therefore, the display control circuit 10 may transmit the first initial enable signal CH_SEL_1 and the second initial enable signal CH_SEL_2 to the signal conversion circuit 31 for further processing.

The active level of the first initial enable signal CH_SEL_1 and the second initial enable signal CH_SEL_2 is a high level, and the level amplitude of the high level is 1.8V.

Continuing to refer to FIG. 5C, the signal conversion circuit 31 is further connected to the N laser device driving circuits 32. The signal conversion circuit 31 is configured to convert the first initial enable signal CH_SEL_1 and the second initial enable signal CH_SEL_2 into N target enable signals corresponding to the N groups of laser devices, and transmit any one of the N target enable signals to a corresponding laser device driving circuit 32, output N analog current control signals based on the digital control signal DC_SN, and transmit any one of the N analog current control signals to a corresponding laser device driving circuit 32.

Any one of the laser device driving circuits 32 is configured to provide a driving current to a group of laser devices connected to the any one of the laser device driving circuits 32 in response to the received target enable signal and analog current control signal. The laser device is configured to emit light due to a driving current provided by a laser device driving circuit 32 connected to the laser device.

In some embodiments, the N target enable signals output by the signal conversion circuit 31 are configured to control the working states of the N laser device driving circuits 32, for example, to control whether any one of the laser device driving circuit 32 outputs the driving current, thereby achieving the control of the light-emitting duration of the laser device connected to the laser device driving circuit 32.

In this case, the N analog current control signals output by the signal conversion circuit 31 are configured to control a magnitude of the driving current provided by the laser device driving circuit 32 to a group of laser devices connected to the laser device driving circuit 32.

It can be understood that in a case where the level of the target enable signal is an active level, the laser device driving circuit 32 outputs the driving current, and the group of laser devices connected to the laser device driving circuit 32 emit light under driving of the driving current. Furthermore, in a case where a signal value of the analog current control signal is increased, a current value of the driving current is increased, so that the light intensity of the laser beam emitted by the group of laser devices is increased. In a case where the level of the target enable signal is an inactive level, the laser device driving circuit 32 stops outputting the driving current, and the group of laser devices connected to the laser device driving circuit 32 stops emitting light.

In some embodiments, the level amplitude of the active level of the N target enable signals is higher than the level amplitude of the active level of the first initial enable signal CH_SEL_1 and the second initial enable signal CH_SEL_2. For example, the level amplitude of the active level of the N target enable signals is 3.3V, and the level amplitude of the active level of the first initial enable signal CH_SEL_1 and the second initial enable signal CH_SEL_2 is 1.8V.

It can be understood that the display control circuit 10 in some embodiments of the present disclosure is configured to output two initial enable signals (e.g., the first initial enable signal CH_SEL_1 and the second initial enable signal CH_SEL_2), but the light source driving circuit 30 includes N laser device driving circuits 32, and N is an integer greater than 2 (e.g., the value of N is 3). In this case, the two initial enable signals is not capable of controlling the working states of the laser device driving circuits 32 whose number is greater than 2. Furthermore, since the level amplitude of the active level of the two initial enable signals is also different from the level amplitude (e.g., 3.3V) of the driving current required by the laser device driving circuit 32, any one of the initial enable signals is not capable of directly controlling a working state of a laser device driving circuit 32.

In this case, the signal conversion circuit 31 may generate N target enable signals corresponding to the number of laser device driving circuits 32 based on level states of the two initial enable signals, and the level amplitude of the N target enable signals is the same as the level amplitude of the driving current required by the laser device driving circuit 32. Thus, the control of the working states of the N laser device driving circuits 32 are implemented.

In some embodiments, referring to FIG. 5C, the value of N is 3, and the light source assembly 40 includes a laser device 40_R, a laser device 40_G, and a laser device 40_B. The laser device 40_R is connected to a laser device driving circuit 32_R, the laser device 40_G is connected to a laser device driving circuit 32_G, and the laser device 40_B is connected to a laser device driving circuit 32_B. Correspondingly, the signal conversion circuit 31 outputs target enable signals R_EN, G_EN and B_EN to the three laser device driving circuits, respectively. For example, the three laser device driving circuits 32 have the same structure.

It can be understood that, if the laser device driving circuit 32 directly controls the magnitude of the output driving current based on the digital signal DC_SN, it will cause the projection image projected by the projection apparatus 100 to have a flickering problem. Therefore, in some embodiments, the signal conversion circuit 31 may generate N analog current control signals based on the digital control signal DC_SN to control the magnitudes of the driving currents output by the N laser device driving circuits 32.

In some embodiments, referring to FIG. 5C, if the value of N is 3, the signal conversion circuit 31 is further configured to output an analog R_AC signal, an analog G_AC signal and an analog B_AC signal to the three laser device driving circuits, respectively.

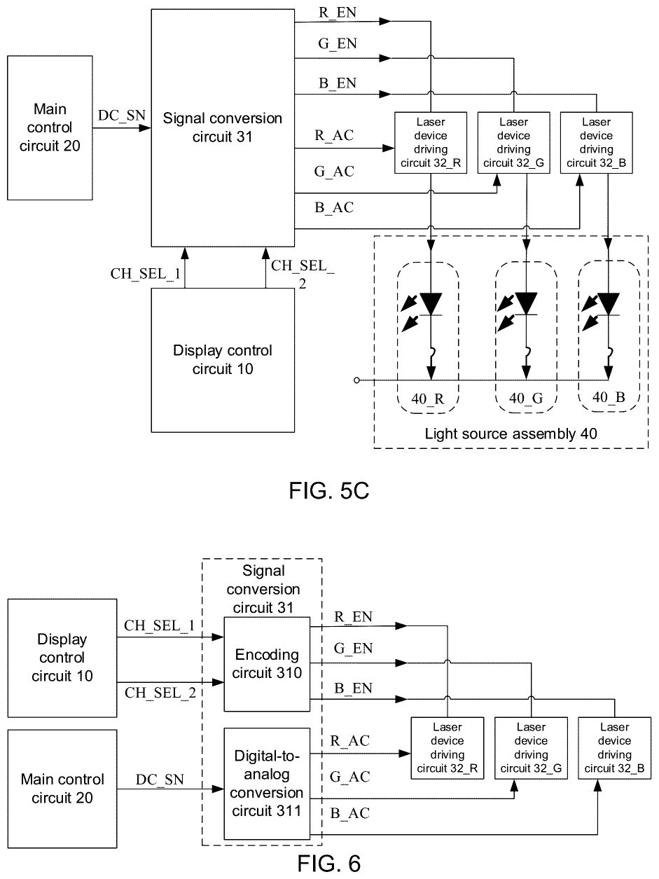

FIG. 6 is a block diagram of yet another projection apparatus, in accordance with some embodiments of the present disclosure. Referring to FIG. 6, the signal conversion circuit 31 includes an encoding circuit 310 and a digital-to-analog conversion circuit 311.

The encoding circuit 310 is connected to the display control circuit 10 and the N laser device driving circuits 32, respectively. The encoding circuit 310 is configured to convert the first initial enable signal CH_SEL_1 and the second initial enable signal CH_SEL_2 into the N target enable signals corresponding to the N groups of laser devices, and transmit any one of the N target enable signals to the corresponding laser device driving circuit 32.

In some embodiments, the active level of any one of the N target enable signals is a first level, and the active levels of the first initial enable signal CH_SEL_1 and the second initial enable signal CH_SEL_2 are both second levels. The first level is higher than the second level. For example, an amplitude of the first level is 3.3V, and an amplitude of the second level is 1.8V.

In some embodiments, the encoding circuit 310 may encode and perform the level conversion on the first initial enable signal CH_SEL_1 and the second initial enable signal CH_SEL_2 to obtain the N target enable signals corresponding to the number of laser device driving circuits 32, and the level amplitude of the active level of the N target enable signals is the same as a level amplitude of the active level of the driving current required by the laser device driving circuit 32. Thus, the control of the working states of the N laser device driving circuits 32 are implemented.

Based on this, in a case where the level of the target enable signal received by the laser device driving circuit 32 is an active level, the laser device driving circuit 32 outputs the driving current, and a group of laser devices connected to the laser device driving circuit 32 emit light under driving of the driving current. In a case where the level of the target enable signal received by the laser device driving circuit 32 is an inactive level, the laser device driving circuit 32 stops outputting the driving current, and the group of laser devices connected to the laser device driving circuit 32 stops emitting light.

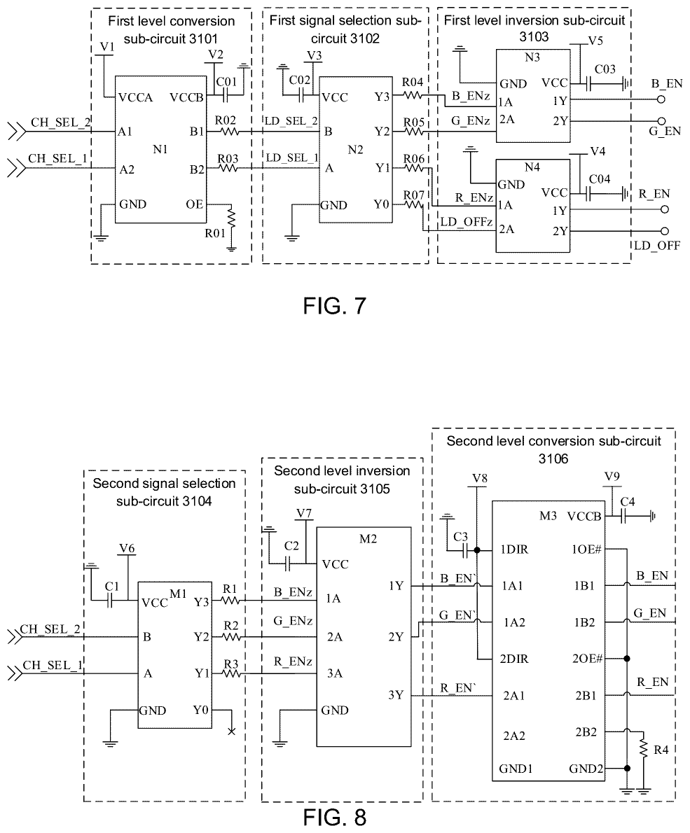

FIG. 7 is a circuit diagram of an encoding circuit, in accordance with the embodiments of the present disclosure.

In some embodiments, referring to FIG. 7, the encoding circuit 310 includes a first level conversion sub-circuit 3101, a first signal selection sub-circuit 3102, and a first level inversion sub-circuit 3103.

The first level conversion sub-circuit 3101 is connected to the display control circuit 10 and the first signal selection sub-circuit 3102. The first level conversion sub-circuit 3101 is configured to perform a level conversion on the first initial enable signal CH_SEL_1 and the second initial enable signal CH_SEL_2 provided by the display control circuit 10, and transmit the converted signals to the first signal selection sub-circuit 3102.

The first signal selection sub-circuit 3102 is further connected to the first level inversion sub-circuit 3103. The first signal selection sub-circuit 3102 is configured to output N intermediate enable signals based on the first initial enable signal LD_SEL_1 and the second initial enable signal LD_SEL_2 after the level conversion.

The first level inversion sub-circuit 3103 is connected to the N laser device driving circuits 32, and is configured to invert the levels of the N intermediate enable signals to obtain N target enable signals, and transmit any one of the N target enable signals to a corresponding laser device driving circuit 32.

In some embodiments, a level of one of the N intermediate enable signals output by the first signal selection sub-circuit 3102 is a low level (e.g., the third level, 0V), or the levels of the N intermediate enable signals are all high levels (e.g., the first level). In this case, a level of one of the N target enable signals obtained after the first level inversion sub-circuit 3103 inverts the levels of the N intermediate enable signals is a high level (e.g., the first level), or the levels of the N target enable signals are all low levels (e.g., the fourth level).

For example, the first level is higher than the third level, and the first level is higher than the fourth level.

In some embodiments, as shown in FIG. 7, the first level conversion sub-circuit 3101 includes a first level conversion chip N1.

A power terminal VCCA of the first level conversion chip N1 is connected to a first power terminal V1, and a power terminal VCCB of the first level conversion chip N1 is connected to a second power terminal V2. An input terminal A1 and an input terminal A2 of the first level conversion chip N1 are connected to the display control circuit 10. An output terminal B1 of the first level conversion chip N1 is connected to an input terminal B of the first signal selection sub-circuit 3102, and an output terminal B2 of the first level conversion chip N1 is connected to an input terminal A of the first signal selection sub-circuit 3102. A power terminal GND and an output enable terminal OE of the first level conversion chip N1 are both connected to a ground terminal.

For example, a voltage value of the first power terminal V1 is 1.8V, and a voltage value of the second power terminal V2 is 3.3V.

In some embodiments, in a case where the first level conversion chip N1 receives the first initial enable signal CH_SEL_1 and the second initial enable signal CH_SEL_2 through the input terminal A1 and the input terminal A2, the level amplitude of the active level of the first initial enable signal CH_SEL_1 and the second initial enable signal CH_SEL_2 may be converted. The level amplitude of the active level of the first initial enable signal LD_SEL_1 and the second initial enable signal LD_SEL_2 after the level conversion is the same as the voltage value of the second power terminal V2.

In some embodiments, referring to FIG. 7, the first level conversion sub-circuit 3101 further includes a resistor R01, a resistor R02, a resistor R03 and a capacitor C01.

For example, the resistor R01 is connected between the output enable terminal OE of the first level conversion chip N1 and the ground terminal of the first level conversion sub-circuit 3101. The resistor R02 is connected between the output terminal B1 of the first level conversion chip N1 and the input terminal B of the first signal selection sub-circuit 3102. The resistor R03 is connected between the output terminal B2 of the first level conversion chip N1 and the input terminal A of the first signal selection sub-circuit 3102. A first terminal of the capacitor C01 is connected to the power terminal VCCB of the first level conversion chip N1 and the second power terminal V2, and a second terminal of the capacitor C01 is connected to the ground terminal of the first level conversion sub-circuit 3101.

The first signal selection sub-circuit 3102 includes a first decoder N2 that may implement 2-line to 4-line conversion. A power terminal VCC of the first decoder N2 is connected to a third power terminal V3, a power terminal GND of the first decoder N2 is connected to a ground terminal, and an output terminal Y0, an output terminal Y1, an output terminal Y2 and an output terminal Y3 of the first decoder N2 are connected to the first level inversion sub-circuit 3103.

In some embodiments, referring to FIG. 7, the selection sub-circuit 3102 further includes a resistor R04, a resistor R05, a resistor R06, a resistor R07, and a capacitor C02.

For example, the resistor R04 is connected between the output terminal Y3 of the first decoder N2 and the first level inversion sub-circuit 3103. The resistor R05 is connected between the output terminal Y2 of the first decoder N2 and the first level inversion sub-circuit 3103. The resistor R06 is connected between the output terminal Y1 of the first decoder N2 and the first level inversion sub-circuit 3103. The resistor R07 is connected between the output terminal Y0 of the first decoder N2 and the first level inversion sub-circuit 3103.

For example, a first terminal of the capacitor C02 is connected to the power terminal VCC of the first decoder N2 and the third power terminal V3, and a second terminal of the capacitor C02 is connected to the ground terminal of the selection sub-circuit 3102.

In some embodiments, the first decoder N2 may decode the levels of the first initial enable signal LD_SEL_1 and the second initial enable signal LD_SEL_2 after level conversion to obtain the N intermediate enable signals.

In some embodiments, referring to FIG. 7, in a case where the value of N is 3, the output terminal Y1, the output terminal Y2, and the output terminal Y3 of the decoder N2 respectively output three intermediate enable signals R_ENz, G_ENz, and B_ENz. A truth table of the first decoder N2 during encoding is shown in Table 1.

TABLE 1

| | | | | | | RGB light-emitting |
|---|---|---|---|---|---|---|
| | | | | | | control signal |
| N2 (input) | | N2 (output) | | | | Encoding |
| A(CH_SEL_1) | B(CH_SEL_2) | Y0 | Y1 | Y2 | Y3 | output results |
| L | L | L | H | H | H | LD_OFFz |
| H | L | H | L | H | H | Red |
| L | H | H | H | L | H | Green |
| H | H | H | H | H | L | Blue |

In Table 1, “L” indicates that the level of the signal received by the input terminal or the signal output by the output terminal of the first decoder N2 is low (the level amplitude is, for example, 0), and “H” indicates that the level of the signal received by the input terminal or the signal output by the output terminal of the first decoder N2 is high.

For example, the RGB light-emitting control signal is a target enable signal in the target enable signals output by the encoding circuit 310 whose level is an active level. The target enable signal may control a first group of laser devices in the three groups of laser devices to emit red light, a second group of laser devices to emit green light, and a third group of laser devices to emit blue light. In a case where the RGB light-emitting control signal is LD_OFFz, the three groups of laser devices do not emit light.

Referring to Table 1, in a case where the first initial enable signal LD_SEL_1 and the second initial enable signal LD_SEL_2 after the level conversion are both at the inactive level “L” (i.e., the low level), the levels of the intermediate enable signals output by the output terminals Y1, Y2 and Y3 of the first decoder N2 are respectively at the high level “H”.

In a case where the level of the first initial enable signal LD_SEL_1 is the active level “H” (i.e., high level) and the second initial enable signal LD_SEL_2 is the inactive level “L”, the level of the intermediate enable signal output by the output terminal Y1 is the low level “L”, and the levels of the intermediate enable signals output by the output terminals Y2 and Y3 are respectively the high level “H”.

In a case where the level of the first initial enable signal LD_SEL_1 is the inactive level “L” and the second initial enable signal LD_SEL_2 is the active level “H”, the levels of the intermediate enable signals output by the output terminals Y1 and Y3 are respectively high level “H”, and the level of the intermediate enable signal output by Y2 is low level “L”.

In a case where the levels of the first initial enable signal LD_SEL_1 and the second initial enable signal LD_SEL_2 are respectively at the active level “H”, the levels of the intermediate enable signals output by the output terminals Y1 and Y2 are respectively at the high level “H”, and the level of the intermediate enable signal output by Y3 is at the low level “L”.

In some embodiments, referring to FIG. 7, the first level inversion sub-circuit 3103 includes a first inverter N3 and a second inverter N4.

An input terminal 1A of the second inverter N4 is connected to the output terminal Y1 of the first decoder N2, and an input terminal 2A of the second inverter N4 is connected to the output terminal Y0 of the first decoder N2. A power terminal GND of the second inverter N4 is connected to the ground terminal, and a power terminal VCC of the second inverter N4 is connected to a fourth power terminal V4.

An output terminal 1Y of the second inverter N4 is connected to the laser device driving circuit 32_R for driving the red laser device, and the output terminal 1Y of the second inverter N4 is configured to output the target enable signal R_EN. An output terminal 2Y of the second inverter N4 is not connected, or, in a case where the value of N is 4, the output terminal 2Y of the first inverter N3 is connected to a laser device driving circuit.

An input terminal 1A of the first inverter N3 is connected to the output terminal Y3 of the first decoder N2, and an input terminal 2A of the first inverter N3 is connected to the output terminal Y2 of the first decoder N2. A power terminal GND of the first inverter N3 is connected to the ground terminal, and a power terminal VCC of the first inverter N3 is connected to a fifth power terminal V5.

The output terminal 1Y of the first inverter N3 is connected to the laser device driving circuit 32_B for driving the blue laser device, and the output terminal 1Y is configured to output the target enable signal B_EN. The output terminal 2Y of the first inverter N3 is connected to the laser device driving circuit 32_G for driving the green laser device, and the output terminal 2Y outputs the target enable signal G_EN. For example, voltage values of the power supplies connected to the fourth power terminal V4 and the fifth power terminal V5 are both 3.3V.

In some embodiments, referring to FIG. 7, the first level inversion sub-circuit 3103 further includes a capacitor C03 and a capacitor C04. A first terminal of the capacitor C03 is connected to the power terminal VCC of the first inverter N3 and the fifth power terminal V5, and a second terminal of the capacitor C03 is connected to the ground terminal. A first terminal of the capacitor C04 is connected to the power terminal VCC of the second inverter N4 and the fourth power terminal V4, and a second terminal of the capacitor C04 is connected to the ground terminal.

It can be understood that an active level of a working enable terminal of the laser device driving circuit 32 is a high level, but the active level of the intermediate enable signal output by the first signal selection sub-circuit 3102 is a low level. Therefore, in some embodiments, the level of the intermediate enable signal is inverted by the inverter in the inverting sub-circuit 3103, and the inverted signal is output as the target enable signal. Therefore, the active level of the target enable signal output by the encoding circuit 310 is made the same as the active level of the working enable terminal of the laser device driving circuit.

FIG. 8 is a circuit diagram of another encoding circuit, in accordance with the embodiments of the present disclosure.

In some embodiments, referring to FIG. 8, the encoding circuit 310 includes a second signal selection sub-circuit 3104, a second level inversion sub-circuit 3105, and a second level conversion sub-circuit 3106.

The second signal selection sub-circuit 3104 is connected to the display control circuit 10 and the second level inversion sub-circuit 3105, and the second signal selection sub-circuit 3104 is configured to output N intermediate enable signals based on the first initial enable signal CH_SEL_1 and the second initial enable signal CH_SEL_2.

The second level inversion sub-circuit 3105 is further connected to the second level conversion sub-circuit 3106, and the second level inversion sub-circuit 3105 is configured to invert the levels of the N intermediate enable signals and transmit the N intermediate enable signals to the second level conversion sub-circuit 3106.

The second level conversion sub-circuit 3106 is connected to the N laser device driving circuits 32, and the second level conversion sub-circuit 3106 is configured to perform the level conversion on the inverted N intermediate enable signals to obtain the N target enable signals, and transmit any one of the N target enable signals to a corresponding laser device driving circuit 32.

As shown in FIG. 8, the second signal selection sub-circuit 3104 includes a second decoder M1 that may implement 2-line to 4-line conversion. The second level inversion sub-circuit 3105 includes a third inverter M2, and the second level conversion sub-circuit 3106 includes a second level conversion chip M3.

A power terminal VCC of the second decoder M1 is connected to a sixth power terminal V6, and a power terminal GND of the second decoder M1 is connected to the ground terminal. An input terminal A and an input terminal B of the second decoder M1 are connected to the display control circuit 10 and are configured to receive the first initial enable signal CH_SEL_1 and the second initial enable signal CH_SEL_2.

An output terminal Y0 of the second decoder M1 is not connected. An output terminal Y1 of the second decoder M1 is connected to an input terminal 3A of the third inverter M2, an output terminal Y2 of the second decoder M1 is connected to an input terminal 2A of the third inverter M2, and an output terminal Y3 of the second decoder M1 is connected to an input terminal 1A of the third inverter M2.

An output terminal 1Y of the third inverter M2 is connected to an input terminal 1A1 of the second level conversion chip M3, an output terminal 2Y of the third inverter M2 is connected to an input terminal 1A2 of the second level conversion chip M3, and an output terminal 3Y of the third inverter M2 is connected to an input terminal 1A3 of the second level conversion chip M3. A power terminal VCC of the third inverter M2 is connected to a seventh power terminal V7.

Output terminals 1B1, 1B2 and 2B1 of the second level conversion chip M3 are respectively connected to the three laser device driving circuits. Power terminals 1DIR and 2DIR of the second level conversion chip M3 are connected to an eighth power terminal V8, and a power terminal VCCB of the second level conversion chip M3 is connected to a ninth power terminal V9.

For example, the voltage values of the power supplies connected to the sixth power source terminal V6, the seventh power source terminal V7, and the eighth power source terminal V8 are all 1.8V, and the voltage value of the power source connected to the ninth power source terminal V9 is 3.3V.

In some embodiments, referring to FIG. 8, the second signal selection sub-circuit 3104 further includes a capacitor C1, a resistor R1, a resistor R2, and a resistor R3.

A first terminal of the capacitor C1 is connected to the power terminal VCC of the second decoder M1 and the sixth power terminal V6, and a second terminal of the capacitor C1 is connected to the ground terminal of the second signal selection sub-circuit 3104. The resistor R1 is connected between the output terminal Y3 of the second decoder M1 and the input terminal 1A of the third inverter M2. The resistor R2 is connected between the output terminal Y2 of the second decoder M1 and the input terminal 2A of the third inverter M2. The resistor R3 is connected between the output terminal Y1 of the second decoder M1 and the input terminal 3A of the third inverter M2.

In some embodiments, the second level inversion sub-circuit 3105 further includes a capacitor C2. A first terminal of the capacitor C2 is connected to the power terminal VCC of the third inverter M2 and the seventh power terminal V7, and a second terminal of the capacitor C1 is connected to the ground terminal of the second level inversion sub-circuit 3105.

In some embodiments, the second level conversion sub-circuit 3106 further includes a capacitor C3, a capacitor C4, and a resistor R4.

A first terminal of the capacitor C3 is connected to the power terminal 1DIR of the second level conversion chip M3 and the eighth power terminal V8, and a second terminal of the capacitor C3 is connected to the ground terminal of the second level conversion sub-circuit 3106. A first terminal of the capacitor C4 is connected to the power terminal VCCB of the second level conversion chip M3 and the ninth power terminal V9, and a second terminal of the capacitor C3 is connected to the ground terminal of the second level conversion sub-circuit 3106. A first terminal of the resistor R4 is connected to an output terminal 2B2 of the second level conversion chip M3, and a second terminal of the resistor R4 is connected to the ground end of the second level conversion sub-circuit 3106.

It will be noted that the working principle of each device in the encoding circuit 310 may refer to the above description of the working principle of each device in the encoding circuit shown in FIG. 7.

For example, in the embodiments corresponding to FIG. 7, the encoding circuit 310 first performs the level conversion on the two initial enable signals, and then performs encoding and inversion processing based on the initial enable signals after the level conversion, thereby obtaining the N target enable signals. In the embodiments corresponding to FIG. 8, the encoding circuit 310 first performs encoding and inversion processing based on two initial enable signals, and then performs the level conversion on the plurality of intermediate enable signals obtained after the inversion processing, thereby obtaining the N target enable signals.

For example, in the embodiments corresponding to FIG. 7, the first level conversion sub-circuit only needs to perform the level conversion on two signals, while in the embodiments corresponding to FIG. 8, the second level conversion sub-circuit needs to perform the level conversion on three or four signals.

Therefore, the circuit complexity and cost of the encoding circuit in the embodiments corresponding to FIG. 7 are lower than that in the embodiments corresponding to FIG. 8.

In the embodiments of the encoding circuit 310 corresponding to FIG. 7 and FIG. 8, if the N target enable signals output by the encoding circuit 310 include a first target enable signal R_EN, a second target enable signal G_EN, and a third target enable signal B_EN, levels of the three target enable signals output by the encoding circuit 310 based on the levels of the first initial enable signal CH_SEL_1 and the second initial enable signal CH_SEL_2 include the following four cases.

In case (1), in a case where the first initial enable signal CH_SEL_1 and the second initial enable signal CH_SEL_2 are both at inactive levels, the first target enable signal R_EN, the second target enable signal G_EN and the third target enable signal B_EN are respectively at inactive levels.

In case (2), in a case where the first initial enable signal CH_SEL_1 is at an active level and the second initial enable signal CH_SEL_2 is at an inactive level, the first target enable signal R_EN is at an active level, and the second target enable signal G_EN and the third target enable signal B_EN are at inactive levels respectively.

In case (3), in a case where the first initial enable signal CH_SEL_1 is at an inactive level and the second initial enable signal CH_SEL_2 is at an active level, the second target enable signal G_EN is at an active level, and the first target enable signal R_EN and the third target enable signal B_EN are at inactive levels respectively.

In case (4), in a case where the first initial enable signal CH_SEL_1 and the second initial enable signal CH_SEL_2 are both at active levels, the first target enable signal R_EN and the second target enable signal G_EN are respectively at inactive levels, and the third target enable signal B_EN is at an active level.

It will be noted that in the above four cases, the active level is a high level relative to the inactive level. Based on the above four cases, it can be known that for a group of initial enable signals provided by the display control circuit 10, a number of target enable signals with active levels in the three target enable signals output by the encoding circuit 310 is 0 or 1. That is, the three groups of laser devices in the light source assembly 40 will not be in the light-emitting state at the same time.

The digital-to-analog conversion circuit 311 in the signal conversion circuit 31 shown in FIG. 6 will be introduced below.

Referring to FIG. 6, the digital-to-analog conversion circuit 311 is respectively connected to the main control circuit 20 and N laser device driving circuits 32, and the digital-to-analog conversion circuit 311 is configured to convert the digital control signal DC_SN into the N analog current control signals, and transmit any one of the N analog current control signals to a corresponding laser device driving circuit 32.

In some embodiments, the digital control signal DC_SN is a digital PWM signal transmitted from the main control circuit 20 to the digital-to-analog conversion circuit 311 through the PWM interface. Alternatively, the digital control signal DC_SN is an SPI signal transmitted from the main control circuit 20 to the digital-to-analog conversion circuit 311 through the SPI.

The digital-to-analog conversion circuit 311 outputs the N analog current control signals, and the N analog current control signals are used to control a magnitude of a driving current provided by the laser device driving circuit 32 to a group of laser devices connected thereto. In addition, in a case where the signal value of the analog current control signal is increased, the current value of the driving current is increased, and the light intensity of the laser beams emitted by the group of laser devices are also increased.

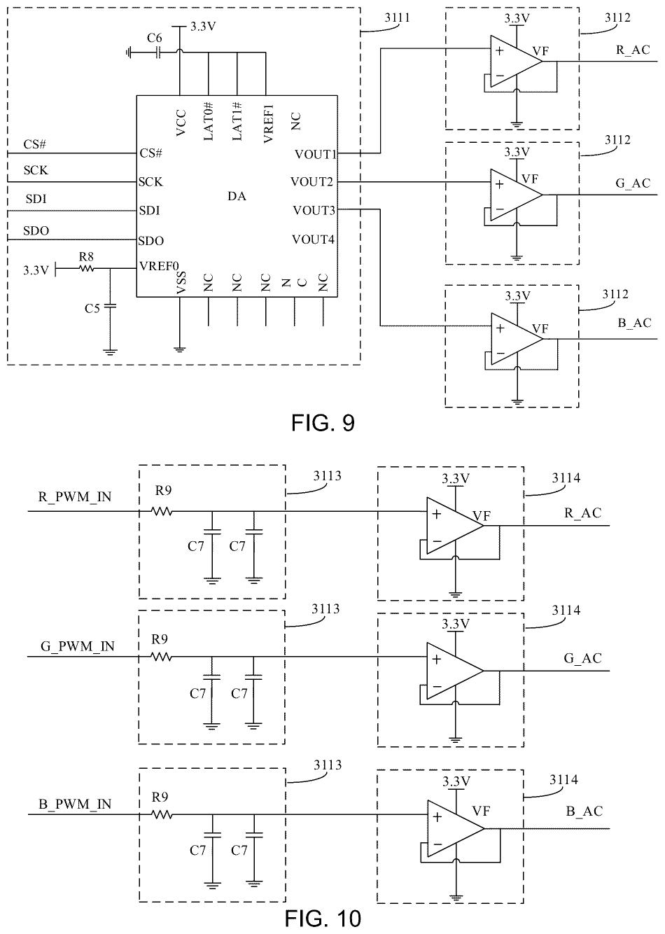

FIG. 9 is a circuit diagram of a digital-to-analog conversion circuit, in accordance with the embodiments of the present disclosure.

In some embodiments, referring to FIG. 9, the digital-to-analog conversion circuit 311 includes a signal generation sub-circuit 3111 and N voltage follower sub-circuits 3112.

The signal generation sub-circuit 3111 is respectively connected to the main control circuit 20 and the N voltage follower sub-circuits 3112. The signal generation sub-circuit 3111 is configured to generate the N analog current control signals based on the digital control signal DC_SN, and transmit any one of the N analog current control signals to a corresponding voltage follower sub-circuit 3112.

The N voltage follower sub-circuits 3112 are connected to the N laser device driving circuits 32, correspondingly. Any one of the N voltage follower sub-circuits 3112 is configured to isolate the interference generated between a laser device driving circuit 32 connected thereto and the signal generation sub-circuit 3111, buffer a received analog current control signal, and transmit the buffered analog current control signal to a corresponding laser device driving circuit 32. For example, a value of N is 3.

In some embodiments, referring to FIG. 9, the signal generation sub-circuit 3111 includes a digital-to-analog conversion chip DA. SPIs of the digital-to-analog conversion chip DA is connected to the SPIs of the main control circuit 20. Output terminals VOUT1, VOUT2 and VOUT1 of the digital-to-analog conversion chip DA are respectively connected to the three voltage follower sub-circuits 3112. A power terminal VCC of the digital-to-analog conversion chip DA is connected to a power terminal with a voltage value of 3.3V.

For example, the SPIs include a chip select (CS) terminal, a serial clock (SCK) terminal, a serial data input (SDI) terminal, and a serial data output (SDO) terminal. The four SPIs are configured to communicate with the main control circuit 20 to receive SPI signals transmitted by the main control circuit 20.

The digital-to-analog conversion chip DA may receive three SPI signals through the SPI communication mode. The digital-to-analog conversion module in the digital-to-analog conversion chip DA processes the three SPI signals to output three analog current signals (analog current control signals), and transmits the three analog current signals to the three voltage follower sub-circuits 3112. For example, the three analog current control signals may control the magnitude of the driving current transmitted by the laser device driving circuit 32 to the laser source.

In some embodiments, referring to FIG. 9, the signal generation sub-circuit 3111 further includes a resistor R8, a capacitor C5, and a capacitor C6.

A first terminal of the resistor R8 is connected to a VREF0 terminal of the digital-to-analog conversion chip DA, and a second terminal of the resistor R8 is connected to a 3.3V power terminal.

A first terminal of the capacitor C5 is connected to a first terminal of the resistor R8 and a VREF0 terminal respectively, and a second terminal of the capacitor C5 is connected to a ground terminal of the signal generation sub-circuit 3111.

A first terminal of the capacitor C6 is connected to a LAT1 port, a LAT1 terminal and a VREF1 terminal of the digital-to-analog conversion chip DA, and a second terminal of the capacitor C6 is connected to the ground terminal of the signal generation sub-circuit 3111.

In some embodiments, for the analog current control signals output by the signal generation sub-circuit 3111, each output terminal of the signal generation sub-circuit 3111 is connected to a voltage follower sub-circuit 3112, so as to ensure that the laser device driving circuit 32 may quickly output or stop outputting the driving current in response to the analog current control signal.

The voltage follower sub-circuit 3112 may buffer and isolate the received analog current control signal to improve the stability of the analog current control signal transmitted to the laser device driving circuit 32, thereby increasing the speed at which the laser device driving circuit 32 responds to the analog current control signal. In addition, the voltage follower sub-circuit 3112 has characteristics of high input impedance and low output impedance, and may play a role of impedance matching in the circuit. Based on this, the voltage follower sub-circuit 3112 may effectively improve the driving capability of the analog current control signal outputted by the voltage follower sub-circuit 3112.

Referring to FIG. 9, any one of the three voltage follower sub-circuits 3112 includes a voltage follower VF. A positive input terminal of the voltage follower VF is connected to an output terminal of the digital-to-analog conversion chip DA, and a negative input terminal of the voltage follower VF is connected to an output terminal of the voltage follower VF. A working voltage of the voltage follower VF is 3.3V. The voltage follower VF is configured to isolate and enhance the driving of the received analog current control signal, so as to improve the driving capability of the analog current control signal.

In some embodiments, referring to FIG. 9, the three voltage follower sub-circuits 3112 in the digital-to-analog conversion circuit 311 output the analog current control signal R_AC for controlling the red laser device driving circuit 32_R, the analog current control signal G_AC for controlling the green laser device driving circuit 32_G, and the analog current control signal B_AC for controlling the blue laser device driving circuit 32_B.

FIG. 10 is a circuit diagram of another digital-to-analog conversion circuit, in accordance with the embodiments of the present disclosure.

In some embodiments, the digital control signal DC_SN output by the main control circuit 20 includes N digital PWM signals. Correspondingly, referring to FIG. 10, the digital-to-analog conversion circuit 311 includes N filtering sub-circuits 3113 and N voltage follower sub-circuits 3114 connected to the N filtering sub-circuits 3113, correspondingly.

The N filtering sub-circuits 3113 are connected to the main control circuit 20, and any one of the N filtering sub-circuits 3113 is configured to filter a digital PWM signal output by the main control circuit 20 to obtain an analog current control signal, and transmit the obtained analog current control signal to a voltage follower sub-circuit 3114 connected thereto.

The N voltage follower sub-circuits 3114 are further connected to the N laser device driving circuits 32 correspondingly, and any one of the N voltage follower sub-circuits 3114 is configured to isolate the interference generated between a laser device driving circuit 32 connected thereto and the filtering sub-circuit 3113, buffer a received analog current control signal, and transmit the buffered analog current control signal to the corresponding laser device driving circuit 32.

In some embodiments, the N digital PWM signals are digital PWM signals transmitted from the main control circuit 20 to the filtering sub-circuit 3113 through the PWM interfaces. In this way, the filtering sub-circuit 3113 may implement the digital-to-analog conversion of the PWM signal.

In some embodiments, referring to FIG. 10, any one of the N filtering sub-circuits 3113 includes a resistor R9 and two capacitors C7. In this way, the filtering of the input digital PWM signal may be implemented by adjusting a resistance value of the resistor R9 and capacitance values of the two capacitors C7.

It will be noted that the function and structure of any one of the N filtering sub-circuits 3113 are the same as the function and structure of the voltage follower sub-circuit 3112 in the digital-to-analog conversion circuit 311 shown in FIG. 9, which will not be repeated here.

The analog current control signal output by the digital-to-analog conversion circuit 311 in the embodiments corresponding to FIG. 9 and FIG. 10 may implement the requirement of the laser device driving circuit to drive the laser source.

In the embodiments corresponding to FIG. 9, software programming is required to send commands, and the software and hardware are combined to implement the output of the analog current control signal. The laser device driving circuit 32 has a fast response speed to output or stop outputting the driving current, so that the display effect of the projection image projected by the projection apparatus is good.

In the embodiments corresponding to FIG. 10, the digital-to-analog conversion circuit 311 has a relatively simple structure and low cost, and may effectively save the space occupied by the digital-to-analog conversion circuit 311 on a printed circuit board (PCB).

The structure and working principle of the optical engine in the projection apparatus provided in some embodiments of the present disclosure are introduced below.

In some embodiments, the N groups of laser devices in the light source assembly 40 of the optical engine include a group of red laser devices, a group of green laser devices, and a group of blue laser devices.

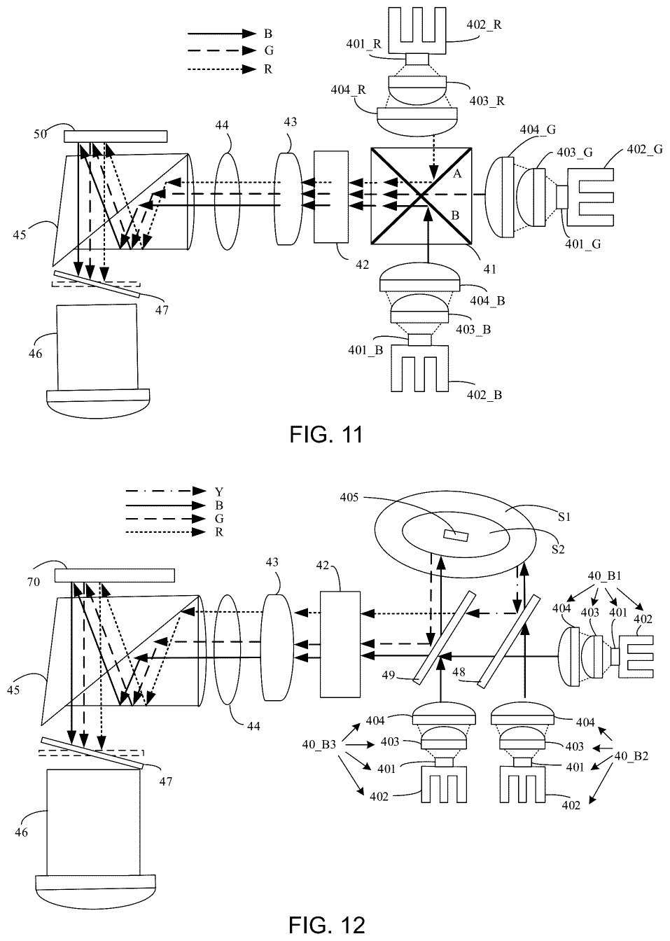

FIG. 11 is a structural diagram of an optical engine, in accordance with the embodiments of the present disclosure. Referring to FIG. 11, the light source assembly 40 in the optical engine includes a red laser source capable of emitting red laser beams, a green laser source capable of emitting green laser beams, and a blue laser source capable of emitting blue laser beams.

In some embodiments, any group of the three groups of laser sources includes: a laser device 401, a laser device heat sink 402, a lens 403, and a lens 404.

The laser devices 401_R, 401_G, and 401_B are configured to generate RGB three-color laser beams. The laser device heat sinks 402_R, 402_G, and 402_B are configured to dissipate heat from the laser source, so as to improve the efficiency of the optical power output by the laser devices 401_R, 401_G, and 401_B. The lens 403 and the lens 404 in any group of laser sources are configured to perform laser shaping on the laser beam emitted by the laser device.

Referring to FIG. 11, the optical engine further includes: a combined prism 41, a diffusion sheet 42, a lens 43, a lens 44, a total internal reflection (TIR) prism group 45, a projection lens 46, and a light valve 50.

The combined prism 41 includes a coated surface A and a coated surface B. The coated surface A may reflect red laser beams and transmit green laser beams and blue laser beams, and the coated surface B may reflect blue laser beams and transmit red laser beams and green laser beams.

In this way, the red laser beams emitted by the red laser device 401_R may be reflected by the coated surface A of the combined prism 41 and enter an optical path after passing through the coated surface B. The green laser beams emitted by the green laser device 401_G may directly pass through the coated surface A and the coated surface B of the combined prism 41 and enter the optical path. The blue laser beams emitted by the blue laser device 401_B may be reflected by the coated surface B of the combined prism 41 and enter the optical path after passing through the coated surface A.

The diffusion sheet 42 is configured to homogenize the RGB three-color laser beams entering the optical path, and the lens 43 and the lens 44 are configured to perform spot shaping on the homogenized RGB three-color laser beams. The RGB three-color laser beams after spot shaping is transmitted through the total internal reflection prism group 45 to be irradiated to the light valve 50, and are transmitted to the projection lens 46 after being reflected by the light valve 50. The projection lens 46 then projects the light beams onto the projection screen to obtain a projected image.

In some embodiments, referring to FIG. 11, the optical engine further includes a vibrating lens 47 to improve the resolution of the projection image projected by the optical engine.

It can be understood that the optical engine in the embodiments corresponding to FIG. 11 has a high system integration, which makes the volume of the optical engine small and facilitates the stacking design of the entire projection apparatus.

In some embodiments, the N groups of laser devices in the light source assembly 40 in the optical engine are all used to emit laser beam of a first color (e.g., blue).

For example, referring to FIG. 12, the light source assembly 40 includes three groups of blue laser sources, and any group of the three groups of blue laser sources includes: a laser device 401, a laser device heat sink 402, a lens 403, and a lens 404.

Referring to FIG. 12, the light source assembly 40 may further include a phosphor wheel 405. The phosphor wheel 405 has a first region S1 and a second region S2. The first region S1 is configured to emit light of a second color after being irradiated by the laser beam of the first color. The second region S2 is configured to emit light of a third color after being irradiated by the laser beam of the first color. The first color, the second color, and the third color are different from each other.

In some embodiments, the first region S1 of the phosphor wheel 405 is coated with phosphor powder of the second color, and the second region S2 is coated with phosphor powder of the third color. The phosphor powder in the first region S1 may be excited to emit a fluorescence beam of the second color after being irradiated by the laser beam of the first color, and the phosphor powder in the second region S2 may be excited to emit a fluorescence beam of the third color after being irradiated by the laser beam of the first color.

For example, if the first region S1 is coated with yellow phosphor powder and the second region S2 is coated with green phosphor powder, the first region S1 may excite yellow fluorescence beam and the second region S2 can excite green fluorescence beam.

In some embodiments, referring to FIG. 11, the first region S1 and the second region S2 are arranged along a radial direction of the phosphor wheel 405. For example, one of the first region S1 and the second region S2 is an outer ring of the phosphor wheel 405, and another is an inner ring of the phosphor wheel 405. For example, the first region S1 is the outer ring of the phosphor wheel 405, and the second region S2 is the inner ring of the phosphor wheel 405.

Compared to the optical engine shown in FIG. 11, in some embodiments, referring to FIG. 12, the optical engine is not provided with a combined prism 41, but a first dichroic lens 48 and a second dichroic lens 49 are provided at the position of the combined prism 41 shown in FIG. 11. The first dichroic lens 48 may transmit blue light and reflect yellow light, and the second dichroic film 49 may transmit blue light and red light, and reflect green light.

For example, referring to FIG. 12, the blue laser beam emitted by the laser source 40_B1 directly passes through the first dichroic lens 48 and the second dichroic lens 49 and enters the optical path.

In a case where the blue laser beam emitted by the laser source 40_B3 passes through the first dichroic film 48 and is irradiated onto the yellow phosphor powder in the first region S1 (e.g., the outer ring) of the phosphor wheel 405, a yellow fluorescence beam is excited. In a case where the yellow fluorescence beam is irradiated onto the first dichroic film 48, the first dichroic film 48 may reflect the yellow fluorescence beam to the second dichroic film 49. The second dichroic film 49 filters out the green light in the yellow fluorescence beam and transmits the red light in the yellow fluorescence beam. As a result, the red light in the yellow fluorescence is output into the optical path.

In a case where the blue laser beam emitted by the laser source 40_B2 passes through the second dichroic film 49 and is irradiated onto the green phosphor in the second region S2 (e.g., the inner circle) of the phosphor wheel 405, the green fluorescence beam may be excited. The green fluorescence is reflected by the second dichroic film 49 and then output to the optical path.

In the embodiments corresponding to FIG. 12, the transmission and processing of the RGB three-color light entering the optical path are the same as the transmission and processing of the RGB three-color light in the embodiments corresponding to FIG. 11 above, and the devices included in the optical engine may also be the same, which will not be repeated here.

In summary, some embodiments of the present disclosure provide a projection apparatus 100, in which the light source driving circuit may provide driving current to a plurality of light sources in a light source assembly in response to a first initial enable signal and a second initial enable signal transmitted by a display control circuit, and a digital control signal transmitted by a main control circuit. Any group of light sources in the light source assembly may emit light under driving of the driving current. The light valve in the projection apparatus may modulate the light emitted by the light sources into the image beams.

Some embodiments of the present disclosure further provide a method for driving a light source of a projection apparatus 100. The method may be applied to the projection apparatus 100 in any one of the above embodiments, such as the projection apparatus 100 shown in FIG. 1.

Referring to FIG. 1, the projection apparatus includes a display control circuit, a main control circuit, a light source driving circuit, a light source assembly and a light valve. The light source assembly includes a plurality of groups of light sources. A size of the light valve is less than a size threshold.

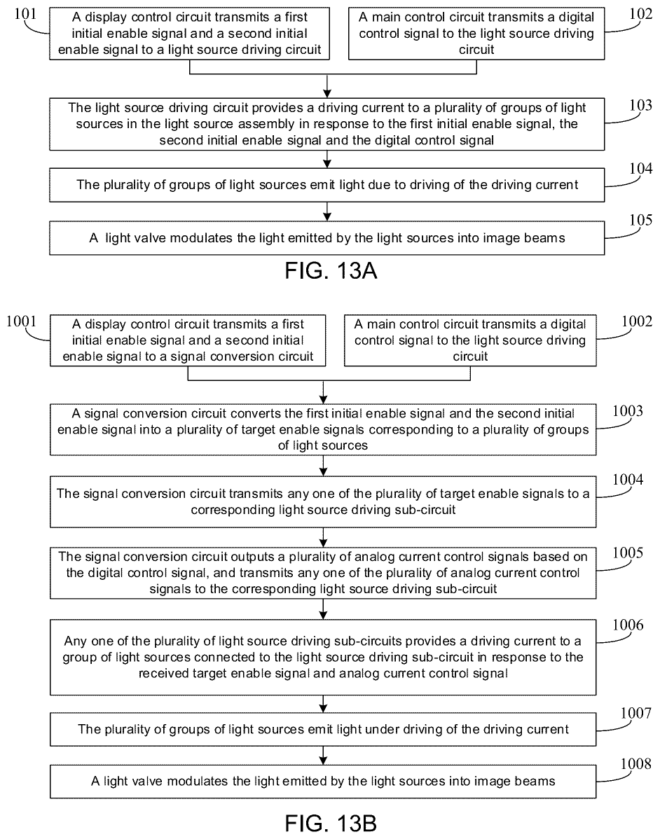

FIG. 13A is a flowchart of a method for driving a light source, in accordance with some embodiments of the present disclosure. As shown in FIG. 13A, the method for driving the light source includes step 101 to step 105.

In step 101, the display control circuit transmits a first initial enable signal and a second initial enable signal to the light source driving circuit.

In some embodiments, the display control circuit may generate the first initial enable signal and the second initial enable signal for controlling the working state of the light source driving circuit based on image data of a projection image to be displayed. For example, the first initial enable signal is also referred to as a first light source lighting enable signal, and the second initial enable signal is also referred to as a second light source lighting enable signal.

In step 102, the main control circuit transmits a digital control signal to the light source driving circuit.

In some embodiments, the digital control signal is a level signal outputted by an output terminal of the main control circuit. Alternatively, the digital control signal is a digital PWM signal output by the main control circuit through a PWM interface. Alternatively, the digital control signal is an SPI signal output by the main control circuit through a serial peripheral interface (SPI).

In step 103, the light source driving circuit provides a driving current to the plurality of groups of light sources in the light source assembly in response to the first initial enable signal, the second initial enable signal and the digital control signal.

For example, the first initial enable signal and the second initial enable signal may control whether the light source driving circuit transmits the driving current to the light source assembly. Regarding the function of the digital control signal, in some embodiments, in a case where the plurality of groups of light sources in the light source assembly are laser sources, the digital control signal may control the magnitude of the driving current transmitted from the light source driving circuit to the light source assembly.

In some embodiments, in a case where the plurality of groups of light sources in the light source assembly are LED light sources, the digital control signal may control the working state of the light source driving circuit. For example, in a case where the digital control signal is at an active level, the light source driving circuit is in the working state. In a case where the digital control signal is at an inactive level, the light source driving circuit is in a state of stopping working.

In step 104, the plurality of groups of light sources emit light due to driving of a driving current.

In some embodiments, the plurality of groups of light sources in the light source assembly are laser sources, and accordingly, the projection apparatus is a laser projection apparatus. Alternatively, the plurality of groups of light sources in the light source assembly are other types of light sources such as LEDs. For example, the colors of the plurality of groups of light sources are the same or different. For example, the light source assembly includes light sources of three colors: red, green and blue.

In step 105, the light valve modulates the light emitted by the light sources into image beams.

In some embodiments, the light valve may modulate the light emitted by the plurality of groups of light sources in the light source assembly into image beams based on image data of a projection image to be displayed. The image beam is projected onto the projection screen through the projection lens to form the projection image.

For example, the size of the light valve is smaller than a size threshold, such as 0.33 inches or 0.23 inches, and the corresponding optical components, peripheral circuit boards and structural mounting members are correspondingly reduced. Therefore, the volume of the projection apparatus is small, and the projection apparatus is also referred to as a micro projection apparatus.

In summary, some embodiments of the present disclosure provide a method for driving a light source of a projection apparatus, the light source driving circuit in the projection apparatus may provide driving current to a plurality of light sources in a light source assembly in response to a first initial enable signal and a second initial enable signal transmitted by a display control circuit, and a digital control signal transmitted by a main control circuit. The plurality of groups of light sources in the light source assembly may emit light under driving of the driving current. The light valve in the projection apparatus may modulate the light emitted by the light sources into the image beams.

In some embodiments, as shown in FIG. 13B, the light source driving circuit includes a plurality of light source driving sub-circuits and a signal conversion circuit. The signal conversion circuit is connected to the plurality of light source driving sub-circuits. The plurality of light source driving sub-circuits are connected correspondingly to the plurality of groups of light sources.

The method for driving the light source includes step 1001 to step 1008.

In step 1001, the display control circuit transmits a first initial enable signal and a second initial enable signal to the signal conversion circuit.

In step 1002, the main control circuit sends a digital control signal to the signal conversion circuit.

In step 1003, the signal conversion circuit converts the first initial enable signal and the second initial enable signal into a plurality of target enable signals corresponding to the plurality of groups of light sources.

In step 1004, the signal conversion circuit transmits any one of the plurality of target enable signals to a corresponding light source driving sub-circuit.

In step 1005, the signal conversion circuit outputs a plurality of analog current control signals based on the digital control signal, and transmits any one of the plurality of analog current control signals to the corresponding light source driving sub-circuit.

In step 1006, any one of the plurality of light source driving sub-circuits provides a driving current to a group of light sources connected to the light source driving sub-circuit in response to the received target enable signal and analog current control signal.

In step 1007, the plurality of groups of light sources emit light under driving of the driving current.

In step 1008, the light valve modulates the light emitted by the light sources into image beams.

In some embodiments, the light source assembly in the projection apparatus includes a plurality of groups of LED light sources.

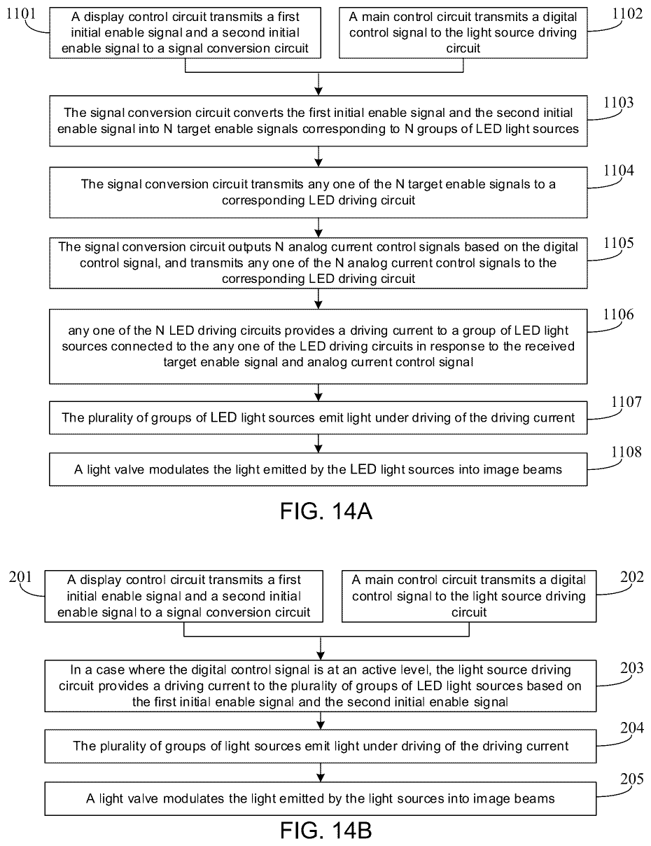

Referring to FIG. 14A, the method for driving the light source of the projection apparatus includes the following step 1101 to step 1108. The plurality of groups of light sources include N groups of LED light sources, and N is an integer greater than 2. The plurality of light source driving sub-circuits include N LED driving circuits.

In step 1101, the display control circuit transmits a first initial enable signal and a second initial enable signal to the signal conversion circuit.

In step 1102, the main control circuit sends a digital control signal to the signal conversion circuit.

In step 1103, the signal conversion circuit converts the first initial enable signal and the second initial enable signal into N target enable signals corresponding to the N groups of LED light sources.

In step 1104, the signal conversion circuit transmits any one of the N target enable signals to a corresponding LED driving circuit.

In step 1105, the signal conversion circuit outputs N analog current control signals based on the digital control signal, and transmits any one of the N analog current control signals to the corresponding LED driving circuit.

In step 1106, any one of the N LED driving circuits provides a driving current to a group of LED light sources connected to the any one of the LED driving circuits in response to the received target enable signal and analog current control signal.

In step 1107, the plurality of groups of LED light sources emit light under the driving of the driving current.

In step 1108, the light valve modulates the light emitted by the LED light sources into image beams.

In some embodiments, the light source assembly in the projection apparatus includes a plurality of groups of LED light sources. Referring to FIG. 14B, the method for driving the light source of the projection apparatus includes steps 201 to 205.

In step 201, the display control circuit transmits a first initial enable signal and a second initial enable signal to the light source driving circuit.

In step 202, the main control circuit transmits a digital control signal to the light source driving circuit.

In step 203, in a case where the digital control signal is at an active level, the light source driving circuit provides a driving current to the plurality of groups of LED light sources based on the first initial enable signal and the second initial enable signal.

In step 204, the plurality of groups of light sources emit light under driving of a driving current.

In step 205, the light valve modulates the light emitted by the light sources into image beams.

In some embodiments, the plurality of groups of light sources are N groups of laser devices, and N is an integer greater than 2. For example, the value of N is 3. The light source driving circuit includes a signal conversion circuit and N laser device driving circuits connected to the N groups of laser devices, correspondingly.

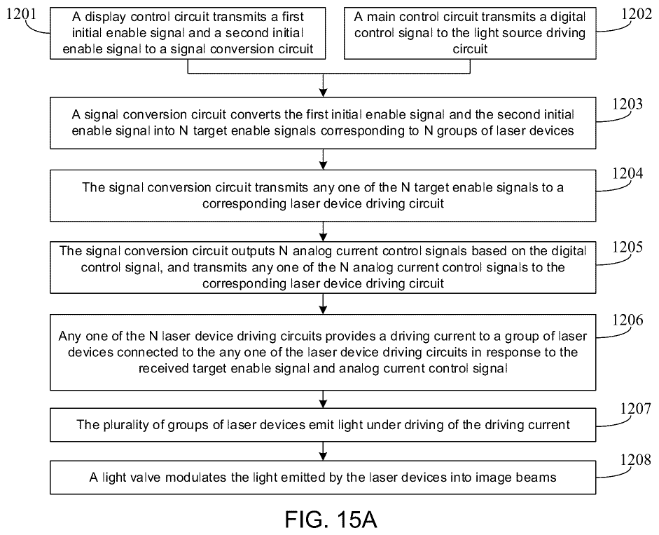

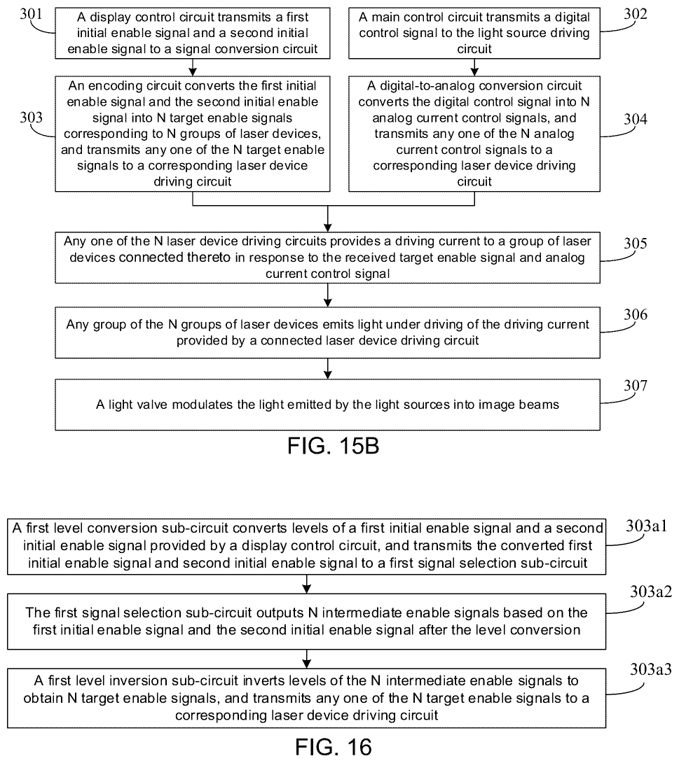

Referring to FIG. 15A, the method for driving the light source of the projection apparatus includes the following step 1201 to step 1208.

In step 1201, the display control circuit transmits a first initial enable signal and a second initial enable signal to the signal conversion circuit.

In step 1202, the main control circuit sends a digital control signal to the signal conversion circuit.

In step 1203, the signal conversion circuit converts the first initial enable signal and the second initial enable signal into N target enable signals corresponding to the N groups of laser devices.

In step 1204, the signal conversion circuit transmits any one of the N target enable signals to a corresponding laser device driving circuit.

In step 1205, the signal conversion circuit outputs N analog current control signals based on the digital control signal, and transmits any one of the N analog current control signals to the corresponding laser device driving circuit.

In step 1206, any one of the N laser device driving circuits provides a driving current to a group of laser devices connected to the any one of the laser device driving circuits in response to the received target enable signal and analog current control signal.

In step 1207, the plurality of groups of laser devices emit light under driving of the driving current.

In step 1208, the light valve modulates the light emitted by the laser devices into image beams.

Referring to FIG. 15B, the method for driving the light source of the projection apparatus includes the following step 301 to step 307.

In step 301, the display control circuit transmits a first initial enable signal and a second initial enable signal to the signal conversion circuit.

For example, the signal conversion circuit includes an encoding circuit and a digital-to-analog conversion circuit, and the encoding circuit is connected to the display control circuit and the N laser device driving circuits. That is, the first initial enable signal and the second initial enable signal may be transmitted to the encoding circuit in the signal conversion circuit, and the encoding circuit further processes the first initial enable signal and the second initial enable signal.

In step 302, the main control circuit transmits a digital control signal to the signal conversion circuit.

For example, the digital-to-analog conversion circuit in the signal conversion circuit is connected to the main control circuit and the N laser device driving circuits. Therefore, the digital control signal may be transmitted to the digital-to-analog conversion circuit in the signal conversion circuit, and the digital-to-analog conversion circuit may further process the digital signal.

In step 303, the encoding circuit converts the first initial enable signal and the second initial enable signal into N target enable signals corresponding to the N groups of laser devices, and transmits any one of the N target enable signals to a corresponding laser device driving circuit.

For example, an active level of any one of the N target enable signals is a first level, active levels of the first initial enable signal and the second initial enable signal are both second levels, and the first level is higher than the second level.

In some embodiments, the encoding circuit includes a first level conversion sub-circuit, a first signal selection sub-circuit, and a first level inversion sub-circuit. For example, the first level conversion sub-circuit is connected to the display control circuit and the first signal selection sub-circuit. The first signal selection sub-circuit is further connected to the first level inversion sub-circuit. The first level inversion sub-circuit is connected to the N laser device driving circuits.

Based on this, as shown in FIG. 16, the implementation process of step 303 includes the following step 303a1 to step 303a3.

In step 303a1, the first level conversion sub-circuit performs level conversion on the first initial enable signal and the second initial enable signal provided by the display control circuit, and transmits the converted first initial enable signal and second initial enable signal to the first signal selection sub-circuit.

In step 303a2, the first signal selection sub-circuit outputs N intermediate enable signals based on the first initial enable signal and the second initial enable signal after level conversion.

In step 303a3, the first level inversion sub-circuit inverts the levels of the N intermediate enable signals to obtain N target enable signals, and transmits any one of the N target enable signals to a corresponding laser device driving circuit.

In some embodiments, the encoding circuit includes a second signal selection sub-circuit, a second level inversion sub-circuit, and a second level conversion sub-circuit. For example, the second signal selection sub-circuit is connected to the display control circuit and the second level inversion sub-circuit, the second level inversion sub-circuit is further connected to the second level conversion sub-circuit, and the second level conversion sub-circuit is connected to the N laser device driving circuits.

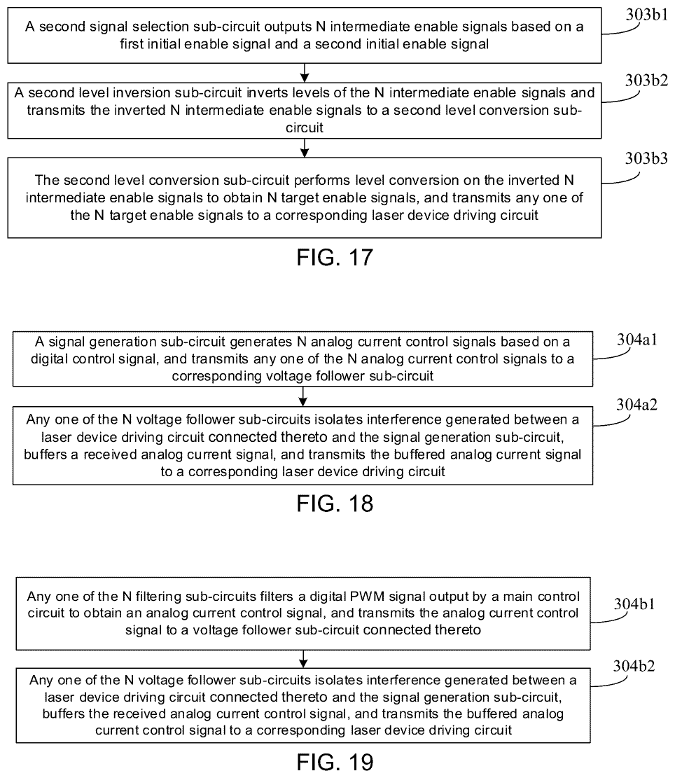

Based on this, as shown in FIG. 17, the implementation process of step 303 includes the following step 303b1 to step 303b3.

In step 303b1, the second signal selection sub-circuit outputs N intermediate enable signals based on the first initial enable signal and the second initial enable signal.

In step 303b2, the second level inversion sub-circuit inverts the levels of the N intermediate enable signals and transmits the inverted N intermediate enable signals to the second level conversion sub-circuit.

In step 303b3, the second level conversion sub-circuit performs level conversion on the inverted N intermediate enable signals to obtain N target enable signals, and transmits any one of the N target enable signals to a corresponding laser device driving circuit.

In the embodiments corresponding to FIG. 16, the encoding circuit first performs the level conversion on the two initial enable signals, and then performs encoding processing and inversion processing based on the initial enable signals after level conversion, so as to obtain the N target enable signals. In the embodiments corresponding to FIG. 17, the encoding circuit first performs encoding and inversion processing based on two initial enable signals, and then performs the level conversion on the plurality of intermediate enable signals obtained after the inversion processing, thereby obtaining the plurality of target enable signals.

In some embodiments, the N target enable signals output by the encoding circuit include a first target enable signal, a second target enable signal, and a third target enable signal. In some embodiments, levels of the three target enable signals output by the encoding circuit based on the levels of the first initial enable signal and the second initial enable signal include the following four cases.

In case (1), in a case where the first initial enable signal and the second initial enable signal are both at inactive levels, the first target enable signal, the second target enable signal and the third target enable signal are respectively at inactive levels.

In case (2), in a case where the first initial enable signal is at an active level and the second initial enable signal is at an inactive level, the first target enable signal is at an active level, and the second target enable signal and the third target enable signal are at inactive levels respectively.

In case (3), in a case where the first initial enable signal is at an inactive level and the second initial enable signal is at an active level, the second target enable signal is at an active level, and the first target enable signal and the third target enable signal are at inactive levels respectively.

In case (4), in a case where the first initial enable signal and the second initial enable signal are both at active levels, the first target enable signal and the second target enable signal are respectively at inactive levels, and the third target enable signal is at an active level.

It will be noted that, in the above four cases, the active level is a high level relative to the inactive level.

In step 304, the digital-to-analog conversion circuit converts the digital control signal into N analog current control signals, and transmits any one of the N analog current control signals to a corresponding laser device driving circuit.

In some embodiments, the digital-to-analog conversion circuit includes a signal generation sub-circuit and N voltage follower sub-circuits. The signal generation sub-circuit is connected to the main control circuit and the N voltage follower sub-circuits, and the N voltage follower sub-circuits are correspondingly connected to the N laser device driving circuits.

Based on this, as shown in FIG. 18, the implementation process of step 304 includes the following step 304a1 and step 304a2.

In step 304a1, the signal generation sub-circuit generates N analog current control signals based on the digital control signal, and transmits any one of the N analog current control signals to a corresponding voltage follower sub-circuit.

In step 304a2, any one of the N voltage follower sub-circuits isolates interference generated between a laser device driving circuit connected thereto and the signal generation sub-circuit, buffers a received analog current signal, and transmits the buffered analog current signal to a corresponding laser device driving circuit.

In some embodiments, the digital control signal includes N digital PWM signals, and the digital-to-analog conversion circuit includes N filtering sub-circuits and N voltage follower sub-circuits connected to the N filtering sub-circuits correspondingly. The N filtering sub-circuits are further connected to the main control circuit, and the N voltage follower sub-circuits are further connected to the N laser device driving circuits, correspondingly.

Based on this, as shown in FIG. 19, the implementation process of step 304 includes the following step 304b1 and step 304b2.

In step 304b1, any one of the N filtering sub-circuits filters a digital PWM signal output by the main control circuit to obtain an analog current control signal, and transmits the analog current control signal to a voltage follower sub-circuit connected thereto.

In step 304b2, any one of the N voltage follower sub-circuits isolates the interference generated between a laser device driving circuit connected thereto and the signal generation sub-circuit, buffers the received analog current control signal, and transmits the buffered analog current control signal to a corresponding laser device driving circuit.

In step 305, any one of the N laser device driving circuits provides a driving current to a group of laser devices connected thereto in response to the received target enable signal and analog current control signal.

In step 306, any group of the N groups of laser devices emits light under driving of the driving current provided by a laser device driving circuit connected thereto.

For example, the N groups of laser devices include a group of red laser devices, a group of green laser devices, and a group of blue laser devices.

In some embodiments, the N groups of laser devices are configured to emit laser beams of a first color. The laser source assembly further includes a phosphor wheel. The phosphor wheel has a first region and a second region. The first region is configured to emit light of a second color after being irradiated by a laser beam of a first color. The second region is configured to emit light of a third color after being irradiated by the laser beam of the first color. For example, the first color, the second color and the third color are different.

In step 307, the light valve modulates the light emitted by the light sources into image beams.

The implementation process of each step in the above method embodiments refers to the relevant description in the above device embodiments, which will not be repeated here.

It will be noted that, the sequence of steps of the method for driving the light source provided by the embodiments of the present disclosure may be adjusted appropriately, and the steps may also be added or removed according to the situation.

For example, step 201 and step 202 may be performed synchronously, step 301 and step 302 may be performed synchronously, and step 303 and step 304 may be performed synchronously.

Any person skilled in the art could readily conceive of changes or replacements within the technical scope of the present disclosure, which shall all be included in the protection scope of the present disclosure, and will not be described in detail herein.

In summary, some embodiments of the present disclosure provide a method for driving a light source of a projection apparatus, the light source driving circuit in the projection apparatus may provide driving current to the plurality of light sources in the light source assembly in response to the first initial enable signal and the second initial enable signal transmitted by the display control circuit, and the digital control signal transmitted by the main control circuit. Each group of light sources in the light source assembly may emit light under driving of the driving current. The light valve in the projection apparatus may modulate the light emitted by the light sources into the image beams.

Some embodiments of the present disclosure provide a projection apparatus. The projection apparatus includes a memory, a processor, and a computer program stored on the memory, where the processor, upon executing the computer program, implements a method (e.g., the method shown in FIGS. 13A to 19) for driving a light source as provided in the above embodiments.

Some embodiments of the present disclosure provide a computer-readable storage medium storing instructions, when the instructions, upon being loaded and executed by a processor, implements a method (e.g., the method shown in FIGS. 13A to 19) for driving a light source as provided in the above embodiments.

Some embodiments of the present disclosure provide a computer program product including instructions that, when run on a computer, causes the computer to execute a method (e.g., the method shown in FIGS. 13A to 19) for driving a light source as provided in the above embodiments.

It will be noted that any technical solution disclosed in the present disclosure may to some extent solve one or more technical problems and implement certain disclosure objectives. A plurality of technical solutions may also be combined into a comprehensive solution to solve one or more technical problems and implement certain disclosure objectives. It is also possible to choose a combination of partially disclosed technologies to form a comprehensive solution, while adopting relevant art and degradation solutions. However, the technology disclosure method may compensate for the degradation trend and solve one or more technical problems to a certain extent, as well as achieve certain disclosure objectives. Each technology disclosure combined into a complete technical solution constitutes an organic and inseparable overall solution, which solves technical problems and achieves certain disclosure objectives as a whole.

Any technical disclosure in the present disclosure, as well as the recombination of the plurality of technical disclosures, can form a complete technical solution, and can solve one or more of the above-mentioned technical problems to achieve the disclosure purpose, which belongs to the content of the present disclosure and is directly and unambiguously determined based on the content of the present disclosure.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

What is claimed is:

1. A projection apparatus, comprising:
a light source driving circuit;
a display control circuit connected to the light source driving circuit, and configured to transmit a first initial enable signal and a second initial enable signal to the light source driving circuit;
a main control circuit connected to the light source driving circuit, and configured to transmit a digital control signal to the light source driving circuit;
a light source assembly including a plurality of groups of light sources; wherein the light source driving circuit is connected to the plurality of groups of light sources, and the light source driving circuit is configured to provide a driving current to the plurality of groups of light sources in response to the first initial enable signal, the second initial enable signal and the digital control signal; any group of the plurality of groups of light sources is configured to emit light under driving of the driving current; and
a light valve, a size of which is less than a size threshold; the light valve is configured to modulate the light emitted by the light sources into image beams.

2. The projection apparatus according to claim 1, wherein
the light source driving circuit includes:
a plurality of light source driving sub-circuits connected to the plurality of groups of light sources correspondingly; and
a signal conversion circuit connected to the plurality of light source driving sub-circuits; the signal conversion circuit being configured to:
convert the first initial enable signal and the second initial enable signal into a plurality of target enable signals corresponding to the plurality of groups of light sources;
transmit any one of the plurality of target enable signals to a corresponding light source driving sub-circuit; and
output a plurality of analog current control signals based on the digital control signal, and transmit any one of the plurality of analog current control signals to the corresponding light source driving sub-circuit; wherein
any one of the plurality of light source driving sub-circuits is configured to provide the driving current to a group of light sources connected to the any one of the plurality of light source driving sub-circuits in response to the received target enable signal and analog current control signal.

3. The projection apparatus according to claim 2, wherein the plurality of groups of light sources includes N groups of laser devices, and N is an integer greater than 2;
the plurality of light source driving sub-circuits include N laser device driving circuits, and the N laser device driving circuits are connected to the N groups of laser devices correspondingly;
the signal conversion circuit is connected to the N laser device driving circuits; the signal conversion circuit is configured to:
convert the first initial enable signal and the second initial enable signal into N target enable signals corresponding to the N groups of laser devices;
transmit any one of the N target enable signals to a corresponding laser device driving circuit; and
output N analog current control signals based on the digital control signal, and transmit any one of the N analog current control signals to the corresponding laser device driving circuit; wherein
any one of the N laser device driving circuits is configured to provide the driving current to a group of laser devices connected to the any one of the N laser device driving circuits in response to the received target enable signal and analog current control signal.

4. The projection apparatus according to claim 3, wherein the signal conversion circuit includes:
an encoding circuit connected to the display control circuit and the N laser device driving circuits; the encoding circuit being configured to convert the first initial enable signal and the second initial enable signal into the N target enable signals corresponding to the N groups of laser devices, and transmit the N target enable signals to the corresponding laser device driving circuits; and
a digital-to-analog conversion circuit connected to the main control circuit and the N laser device driving circuits; the digital-to-analog conversion circuit being configured to convert the digital control signal into the N analog current control signals, and transmit the any one of the N analog current control signals to the corresponding laser device driving circuit.

5. The projection apparatus according to claim 4, wherein an active level of the any one of the plurality of target enable signals is a first level, active levels of the first initial enable signal and the second initial enable signal are both second levels, and the first level is higher than the second level.

6. The projection apparatus according to claim 4, wherein the encoding circuit includes:
a first level conversion sub-circuit connected to the display control circuit and a first signal selection sub-circuit; the first level conversion sub-circuit being configured to perform a level conversion on the first initial enable signal and the second initial enable signal provided by the display control circuit, and transmit the first initial enable signal and the second initial enable signal after the level conversion to the first signal selection sub-circuit;
the first signal selection sub-circuit connected to a first level inversion sub-circuit; the first signal selection sub-circuit being configured to output N intermediate enable signals based on the first initial enable signal and the second initial enable signal after the level conversion; and
the first level inversion sub-circuit connected to the N laser device driving circuits; the first level inversion sub-circuit being configured to invert N levels of the N intermediate enable signals to obtain the N target enable signals, and transmit the any one of the N target enable signals to the corresponding laser device driving circuit.

7. The projection apparatus according to claim 4, wherein the encoding circuit includes:
a second signal selection sub-circuit connected to the display control circuit and a second level inversion sub-circuit; the second signal selection sub-circuit being configured to output N intermediate enable signals based on the first initial enable signal and the second initial enable signal;
the second level inversion sub-circuit connected to a second level conversion sub-circuit; the second level inversion sub-circuit being configured to invert levels of the N intermediate enable signals, and transmit the inverted N intermediate enable signals to the second level conversion sub-circuit; and
the second level conversion sub-circuit connected to the N laser device driving circuits; the second level conversion sub-circuit being configured to perform a level conversion on the inverted N intermediate enable signals to obtain the N target enable signals, and transmit the any one of the N target enable signals to the corresponding laser device driving circuit.

8. The projection apparatus according to claim 4, wherein the digital-to-analog conversion circuit includes:
a signal generation sub-circuit connected to the main control circuit and N voltage follower sub-circuits; the signal generation sub-circuit being configured to generate the N analog current control signals based on the digital control signal, and transmit any one of the N analog current control signals to a corresponding voltage follower sub-circuit; and
the N voltage follower sub-circuits connected to the N laser device driving circuits correspondingly; any one of the N voltage follower sub-circuits being configured to:
isolate interference generated between a laser device driving circuit connected to the any one of the N voltage follower sub-circuits and the signal generation sub-circuit;
buffer the received corresponding analog current control signal; and
transmit the corresponding buffered analog current control signal to a corresponding laser device driving circuit.

9. The projection apparatus according to claim 4, wherein the digital control signal includes N digital pulse width modulation signals;
the digital-to-analog conversion circuit includes:
N filter sub-circuits connected to N voltage follower sub-circuits correspondingly, and the N filter sub-circuits being connected to the main control circuit; any one of the N filter sub-circuits being configured to filter one of the N digital pulse width modulation signals output by the main control circuit to obtain a corresponding analog current control signal, and transmit the corresponding analog current control signal to a voltage follower sub-circuit connected to the any one of the N filter sub-circuits;
the N voltage follower sub-circuits connected to the N laser device driving circuits correspondingly; any one of the N voltage follower sub-circuits being configured to:
isolate interference generated between a laser device driving circuit connected to any one of the N voltage follower sub-circuits and a filter sub-circuit connected the any one of the N voltage follower sub-circuits;
buffer the received corresponding analog current control signal; and
transmit the corresponding buffered analog current control signal to a corresponding laser device driving circuit.

10. The projection apparatus according to claim 3, wherein the plurality of groups of light sources includes N groups of LED light sources, and N is an integer greater than 2;
the plurality of light source driving sub-circuits include N LED driving circuits, and the N LED driving circuits are connected to the N groups of LED light sources correspondingly;
the signal conversion circuit is connected to the N LED driving circuits; the signal conversion circuit is configured to:
convert the first initial enable signal and the second initial enable signal into N target enable signals corresponding to the N groups of LED light sources;
transmit any one of the N target enable signals to a corresponding LED driving circuit; and
output N analog current control signals based on the digital control signal, and transmit any one of the N analog current control signals to the corresponding LED driving circuit;
wherein any one of the N LED driving circuits is configured to provide the driving current to a group of LED light sources connected to the any one of the N LED driving circuits in response to the received target enable signal and analog current control signal.

11. The projection apparatus according to claim 3, wherein the N target enable signals include a first target enable signal, a second target enable signal and a third target enable signal;
in a case where the first initial enable signal and the second initial enable signal are both at inactive levels, the first target enable signal, the second target enable signal and the third target enable signal are at inactive levels;
in a case where the first initial enable signal is at an active level and the second initial enable signal is at an inactive level, the first target enable signal is at an active level, and the second target enable signal and the third target enable signal are at inactive levels;
in a case where the first initial enable signal is at an inactive level and the second initial enable signal is at an active level, the second target enable signal is at an active level, and the first target enable signal and the third target enable signal are at inactive levels;
in a case where the first initial enable signal and the second initial enable signal are both at active levels, the first target enable signal and the second target enable signal are both at inactive levels, and the third target enable signal is at an active level.

12. The projection apparatus according to claim 3, satisfying at least one of the following:
the any one of the N target enable signals is configured to: control whether the corresponding light source driving sub-circuit outputs the driving current; or
the any one of the N analog current control signals is configured to control a magnitude of the driving current provided by the corresponding light source driving sub-circuit to a group of light sources connected to the corresponding light source driving sub-circuit.

13. The projection apparatus according to claim 1, wherein the plurality of groups of light sources includes a plurality of groups of LED light sources;
the light source driving circuit is configured to provide the driving current to the plurality of groups of LED light sources based on the first initial enable signal and the second initial enable signal in a case where the digital control signal is at an active level.

14. The projection apparatus according to claim 1, wherein the light valve satisfies one of the following:
a size of the light valve is 0.47 inches;
the size of the light valve is 0.33 inches; and
the size of the light valve is 0.23 inches.

15. The projection apparatus according to claim 1, wherein the digital control signal satisfies one of the following:
the digital control signal includes a level signal output by the main control circuit;
the digital control signal includes a digital pulse width modulation signal output by the main control circuit through a pulse width modulation interface; and
the digital control signal includes a serial peripheral interface signal output by the main control circuit through a serial peripheral interface.

16. The projection apparatus according to claim 1, further comprising:
a multimedia processing circuit configured to: receive a video signal and process the video signal to convert the video signal into red green blue color data in a low-voltage differential signaling format; and
an image processing circuit connected to the multimedia processing circuit, and configured to process the red green blue color data in the low-voltage differential signaling format output by the multimedia processing circuit, and transmit the processed image data to the display control circuit.

17. A method for driving a light source of a projection apparatus, wherein the projection apparatus includes: a display control circuit, a main control circuit, a light source driving circuit, a light source assembly and a light valve; the light source assembly includes a plurality of groups of light sources; a size of the light valve is less than a size threshold;
the method comprises:
transmitting, by the display control circuit, a first initial enable signal and a second initial enable signal to the light source driving circuit;
transmitting, by the main control circuit, a first image signal to the display driving circuit;
providing, by the light source driving circuit, a driving current to the plurality of groups of light sources in the light source assembly in response to the first initial enable signal, the second initial enable signal and the digital control signal;
emitting, by any group of the plurality of groups of light sources, light under driving of the driving current; and
modulating, by the light valve, light emitted by the plurality of groups of light sources into image beams.

18. The driving method according to claim 17, wherein the light source driving circuit includes a plurality of light source driving sub-circuits and a signal conversion circuit; the signal conversion circuit is connected to the plurality of light source driving sub-circuits; the plurality of light source driving sub-circuits are connected to the plurality of groups of light sources correspondingly;
the method further comprises:
transmitting, by the display control circuit, the first initial enable signal and the second initial enable signal to the signal conversion circuit;
transmitting, by the main control circuit, the digital control signal to the signal conversion circuit;
converting, by the signal conversion circuit, the first initial enable signal and the second initial enable signal into a plurality of target enable signals corresponding to the plurality of groups of light sources;
transmitting, by the signal conversion circuit, any one of the plurality of target enable signals to a corresponding light source driving sub-circuit;
outputting, by the signal conversion circuit, a plurality of analog current control signals based on the digital control signal, and transmitting, by the signal conversion circuit, any one of the plurality of analog current control signals to the corresponding light source driving sub-circuit; and
providing, by any one of the plurality of light source driving sub-circuits, the driving current to a group of light sources connected to the any one of the light source driving sub-circuits in response to the received target enable signal and analog current control signal.

19. The driving method according to claim 18, wherein the plurality of groups of light sources include N groups of laser devices, and N is an integer greater than 2; the plurality of light source driving sub-circuits include N laser device driving circuits;
the method further comprises:
converting, by the signal conversion circuit, the first initial enable signal and the second initial enable signal into N target enable signals corresponding to the N groups of laser devices;
transmitting, by the signal conversion circuit, any one of the N target enable signals to a corresponding laser device driving circuit;
outputting, by the signal conversion circuit, N analog current control signals based on the digital control signal, and transmitting, by the signal conversion circuit, any one of the N analog current control signals to the corresponding laser device driving circuit; and
providing, by any one of the N laser device driving circuits, the driving current to a group of laser devices connected to the any one laser device driving circuit in response to the received target enable signal and analog current control signal.

20. The driving method according to claim 18, wherein the plurality of groups of light sources include N groups of LED light sources, and N is an integer greater than 2; the plurality of light source driving sub-circuits include N LED driving circuits;
the method further comprises:
converting, by the signal conversion circuit, the first initial enable signal and the second initial enable signal into N target enable signals corresponding to the N groups of LED light sources;
transmitting, by the signal conversion circuit, any one of the N target enable signals to a corresponding LED driving circuit;
outputting, by the signal conversion circuit, N analog current control signals based on the digital control signal, and transmitting, by the signal conversion circuit, any one of the N analog current control signals to the corresponding LED driving circuit; and
providing, by any one of the N LED driving circuits, the driving current to a group of LED light sources connected to the any one of the N LED driving circuits in response to the received target enable signal and analog current control signal.
